(19) United States
(12) Patent Application Publication
(10) Pub. No.: US 2017/0103382 A1
(43) Pub. Date: Apr. 13, 2017

(54) METHOD OF PROVIDING PAYMENT SERVICE AND ELECTRONIC DEVICE FOR IMPLEMENTING SAME

(71) Applicant: Samsung Electronics Co., Ltd., Gyeonggi-do (KR)

(72) Inventors: Bumhan KIM, Seoul (KR); Dasom LEE, Seoul (KR); Seong-Min JE, Gyeonggi-do (KR)

(21) Appl. No.: 15/202,667

(22) Filed: Jul. 6, 2016

(30) Foreign Application Priority Data
Oct. 7, 2015 (KR) 10-2015-0140915

(51) Int. Cl. G06Q 20/32; G06Q 20/40

(52) U.S. Cl. CPC G06Q 20/3278; G06Q 20/4014

(57) ABSTRACT

A method and an apparatus include: executing an application for performing payment in an electronic device including a plurality of resources; selecting one or more resources of the electronic device to be used for performing the payment among the plurality of resources at least based on the execution; and performing the payment through the application by using the one or more resources. Other embodiments are also possible.

### CLAIM OF PRIORITY

This application claims priority under 35 U.S.C. §119(a) to Korean Application Serial No. 10-2015-0140915, which was filed in the Korean Intellectual Property Office on Oct. 7, 2015, the entire content of which is hereby incorporated by reference.

### TECHNICAL FIELD

The present disclosure relates to a method and an apparatus for providing a payment service.

### BACKGROUND

With the development of digital technologies, various electronic devices including mobile communication terminals, Personal Digital Assistants (PDA), electronic organizers, smart phones, tablet Personal Computers (PC), or wearable devices which can perform communication and process personal information while being carried have come to market. The electronic device initially provided a primary service such as a voice call or a Short Message Service (SMS). But recently, these devices provide additional functionality such as photography, navigation, and payment, or a wireless Internet environment.

Users can use various functions on one electronic device alone without the need for a separate camera for photography, a navigation device for way-finding, or a credit card or cash for payment. Accordingly, the electronic device may improve user convenience.

Meanwhile, services have been activated and users who pay for products with a credit card have increased. The credit card is used as a payment means due to its easier portability than cash. That is, the user can make a payment with the credit card without having cash. Increasingly, electronic devices may provide a credit card function to allow for payment of goods and services

A seller (or deliverer) may process a payment by using a Point of Sales (POS) terminal installed in a fixed place such as a store. The POS terminal should meet requirements of a payment policy and, for example, can have software required for payment but cannot have other software. Accordingly, in order to use the POS terminal, authentication from a server that manages the payment policy is needed. Further, in order to use the POS terminal in a mobile place, the POS terminal should enable wireless communication. To this end, an accessory having software required for payment is attached to the electronic device and electronic device with the accessory is used as the POS terminal. The electronic device may simply performs only a communication function, and the accessory performs a payment function. Since the electronic device has other software as well as the software required for payment, a security problem may occur if the electronic device is used as the POS terminal without any accessory.

### SUMMARY

Various embodiments may provide a method and an apparatus for controlling an electronic device (for example, a portable terminal) to use the electronic device as a POS terminal. Further, various embodiments may provide a method and an electronic device for providing a payment service in an electronic device.

In accordance with an aspect of the present disclosure, a method includes: executing an application for performing payment in an electronic device including a plurality of resources; selecting one or more resources of the electronic device to be used for performing the payment among the plurality of resources at least based on the execution; and performing the payment through the application by using the one or more resources.

In accordance with another aspect of the present disclosure, an electronic device including a plurality of resources includes: for example, a communication interface; a memory; and a processor functionally connected to the memory, wherein the processor is configured to perform operations, the operations comprising: executing an application for performing payment; selecting one or more resources of the electronic device to be used for performing the payment among the plurality of resources at least based on the execution; and performing the payment through the application by using the one or more resources.

In accordance with another aspect of the present disclosure, a computer-readable recording medium including a program to execute operations is provided. The operations include: for example, executing an application for performing payment in an electronic device including a plurality of resources; selecting one or more resources of the electronic device to be used for performing the payment among the plurality of resources at least based on the execution; and performing the payment through the application by using the one or more resources.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an electronic device within a network environment according to one embodiment of the present disclosure;

FIG. 2 is a block diagram illustrating a configuration of the electronic device according to one embodiment of the present disclosure;

FIG. 3 is a block diagram of a program module according to one embodiment of the present disclosure;

FIG. 4 is a block diagram illustrating a processor according to one embodiment of the present disclosure;

FIG. 5 is a block diagram illustrating an REE and a TEE operated in the electronic device according to one embodiment of the present disclosure;

FIG. 6A, FIG. 6B and FIG. 6C are block diagrams illustrating a hardware structure of the TEE according to one embodiment of the present disclosure;

FIG. 7 illustrates a configuration of a payment system according to one embodiment of the present disclosure;

FIG. 8 illustrates a payment transaction method according to one embodiment of the present disclosure;

FIG. 9 is a block diagram illustrating a program module of a payment execution environment according to one embodiment of the present disclosure;

FIG. 10 is a flowchart illustrating a method of providing a payment service by an electronic device according to one embodiment of the present disclosure;

FIG. 11 is a flowchart illustrating a method of entering a payment processing mode by an electronic device according to one embodiment of the present disclosure;

FIG. 12 is a flowchart illustrating a payment method of an electronic device according to one embodiment of the present disclosure;

FIG. 13A and FIG. 13B are flowcharts illustrating an operation method of the electronic device according to one embodiment of the present disclosure;

FIG. 14A, FIG. 14B, FIG. 14C, FIG. 14D and FIG. 14E illustrate examples of a user interface screen of the electronic device according to one embodiment of the present disclosure;

FIG. 15 illustrates a process for registering the electronic device as a POS terminal according to one embodiment of the present disclosure; and

FIG. 16 illustrates a payment process using the electronic device according to one embodiment of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer

(PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™, a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

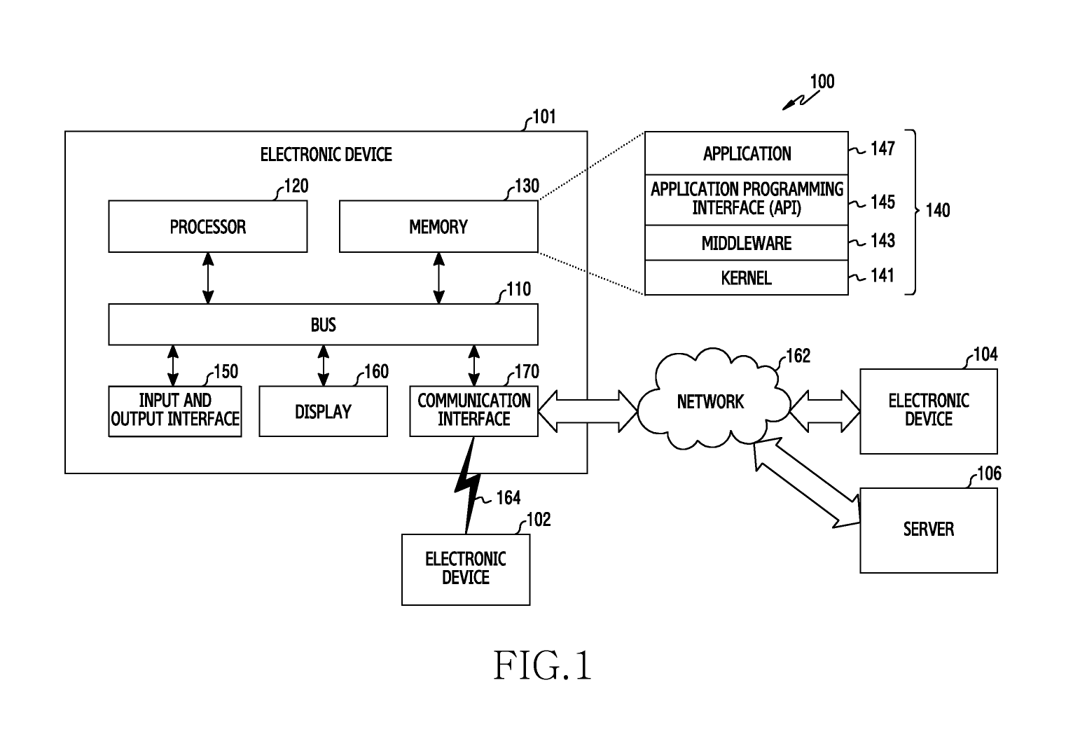

FIG. 1 illustrates a network environment including an electronic device according to one embodiment of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 access functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS).

An Magnetic Secure Transmission (MST) may create a pulse according to transmission data by using an electromagnetic signal, and the pulse may generate a magnetic field signal. The electronic device 101 may transmit the magnetic field signal to a Point Of Sales (POS) device, and the POS device may detect the magnetic field signal using an MST reader and convert the detected magnetic field signal into an electric signal to restore the data.

GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

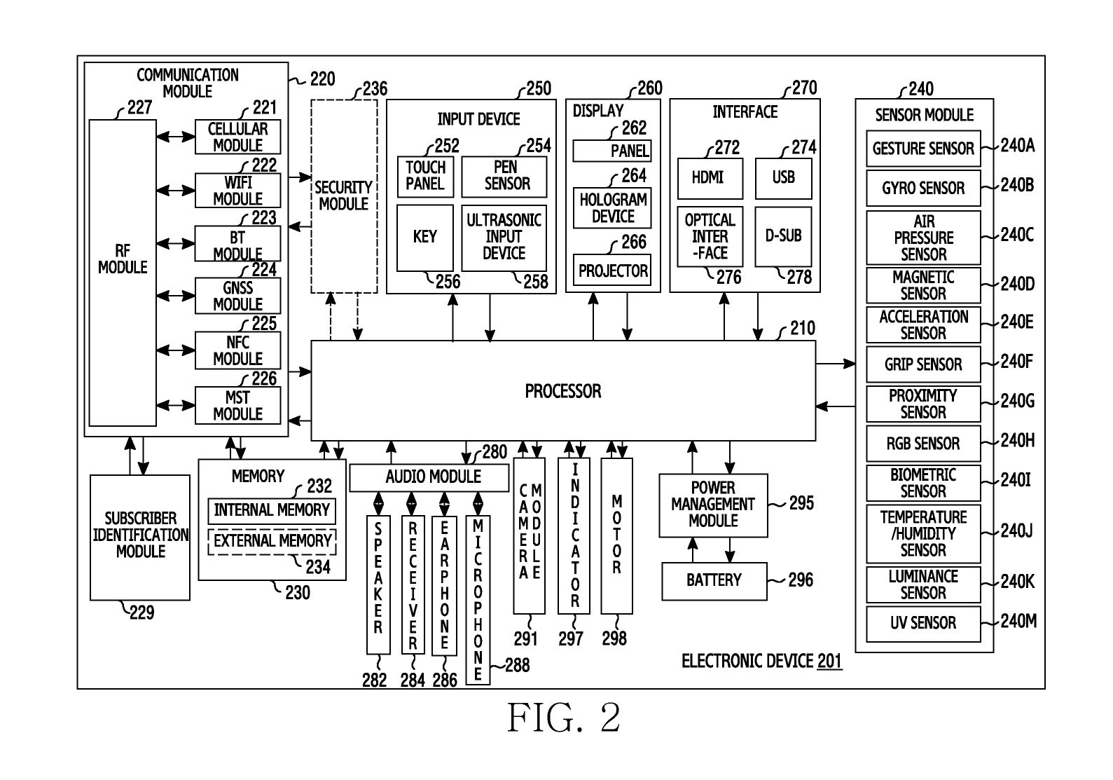

FIG. 2 is a block diagram of an electronic device according to one embodiment of the present disclosure.

The electronic device 201 may include, for example, all or a part of the electronic device 101 shown in FIG. 1. The electronic device 201 may include one or more processors 210 (e.g., Application Processors (AP)), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory. The processor 210 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

The communication module 220 may have a configuration equal or similar to that of the communication interface 170 of FIG. 1. The communication module 220 may include, for example, a cellular module 221, a Wi-Fi module 222, a BlueTooth module 223, a GNSS module 224 (for example, a GPS module, a Glonass module, a

Beidou module, or a Galileo module), an NFC module 225, an MST module 226, and a Radio Frequency (RF) module 227.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (e.g: SIM card) 229 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

For example, each of the Wi-Fi module 222, the BT module 223, the GNSS module 224, and the NFC module 225 may include a processor for processing data transmitted/received through a corresponding module. According to an embodiment of the present disclosure, at least some (e.g., two or more) of the cellular module 221, the Wi-Fi module 222, the BT module 223, the GNSS module 224, and the NFC module 225 may be included in one Integrated Chip (IC) or IC package.

The RF module 227, for example, may transmit/receive a communication signal (e.g., an RF signal). The RF module 227 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 222, the BT module 223, the GNSS module 224, the NFC module 225, an MST module 226 may transmit/receive an RF signal through a separate RF module.

The subscriber identification module 229 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory

(DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces. The security module 236 is a module including a storage space having a higher security level than that of the memory 230 and may be a circuit that guarantees safe data storage and protected execution environment. The security module 236 may be implemented by a separate circuit and may include a separate processor. The security module 236 may exist in, for example, a detachable smart chip or Secure Digital (SD) card or include an embedded Secure Elements (eSE) embedded in a fixed chip of the electronic device 201. Further, the security module 236 may be operated by an Operating System (OS) different from the OS of the electronic device 201. For example, the security module may operate on the basis of a Java Card Open Platform (JCOP) operating system.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared

(IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

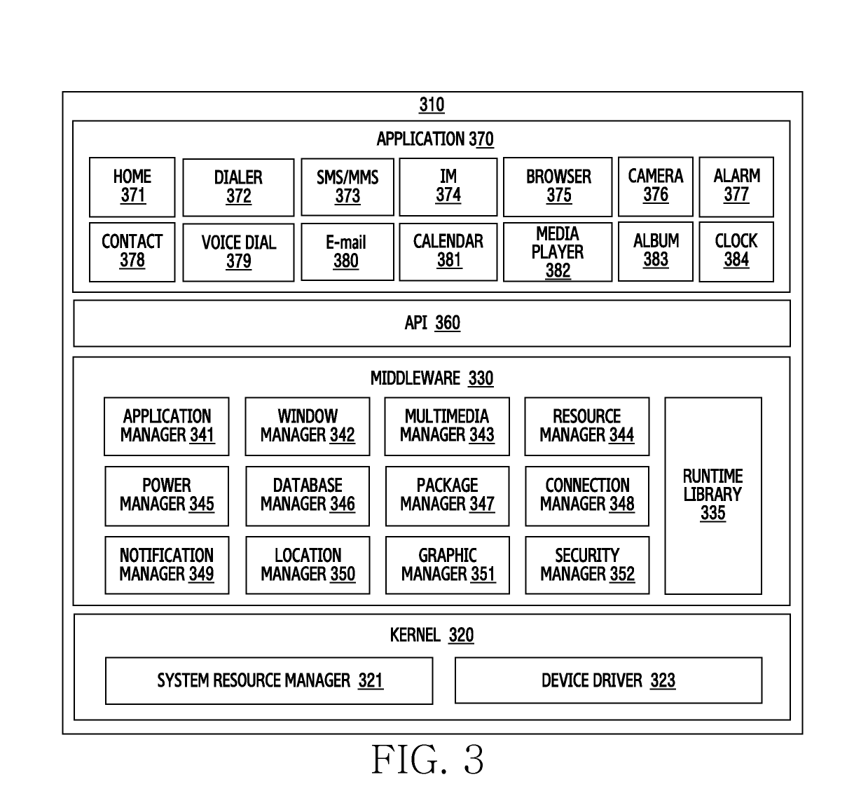

FIG. 3 is a block diagram of a program module according to one embodiment of the present disclosure. According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android ™, iOS™, Windows™, Symbian™, Tizen™, Bada™, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User

Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. Further, the terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The electronic device described below may be the electronic device 101 of FIG. 1 or the electronic device 201 of FIG. 2. For convenience of the description, the electronic device 101 of FIG. 1 is described as an example of the electronic device but the electronic device is not limited thereto by the description.

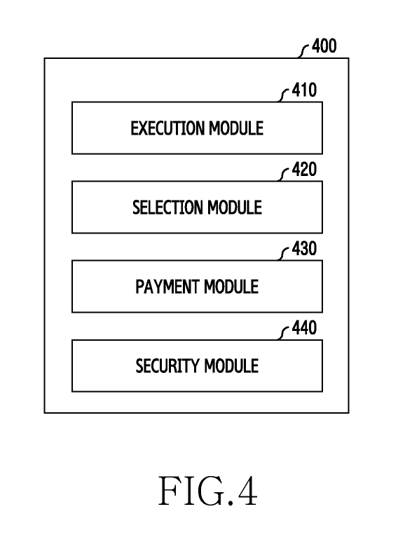

FIG. 4 is a block diagram 400 illustrating a processor according to one embodiment of the present disclosure.

Referring to FIG. 4, the processor 120 may include an execution module 410, a selection module 420, a payment module 430, and a security module 440.

The execution module 410 may execute an application related to payment. For example, the application may change the electronic device 101 to have an environment for the use as a payment terminal of a seller. When the user selects (or touches) the payment application displayed, in an icon form, on the display 160 functionally connected to the electronic device 101, the execution module 410 may execute the payment application. Alternatively, when the user inputs a preset gesture or voice in order to execute the payment application, the execution module 410 may execute the payment application.

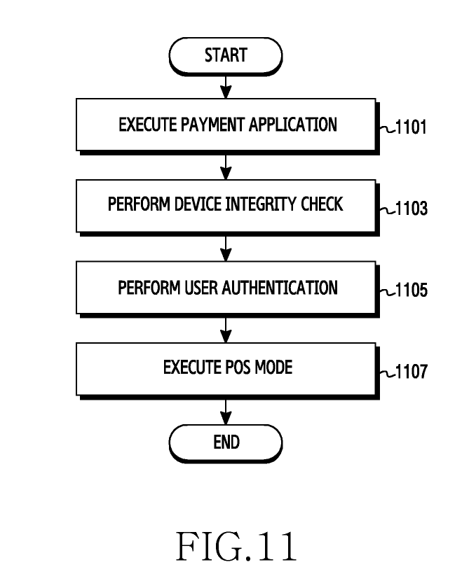

According to various embodiments, when the payment application is executed, the security module 440 may perform an integrity check and/or a user authentication of the electronic device 101, and then enter a payment processing mode (for example, POS mode). The integrity check and the user authentication will be described below in detail through FIG. 11. The payment processing mode may be distinguished from, for example, a mode (for example, normal mode) in which the electronic device 101 is not used as the payment terminal. The payment processing mode is to use the electronic device 101 as the payment terminal and may allow only some operations of the electronic device 101. For example, the payment processing mode may allow only operations for payment and block all operations irrelevant to payment.

The selection module 420 may select one or more resources. For example, when card information (for example, card number (Primary Account Number (PAN), expiration date, Card Verification Value (CVV), and the like) is acquired from the card (for example, credit card), the selection module 420 may select one or more resources required for payment. According to various embodiments, the selection module 420 may select the one or more resources based on a capability of the electronic device 101, a role of the electronic device 101, an amount or function related to the payment, or a combination thereof. The capability of the electronic device 101 may include a hardware capability and/or a software capability of the electronic device 101. The role of the electronic device 101 may include operations which the electronic device 101 should perform to process payment. According to various embodiments, the selection module 420 may further select one or more other resources as well as the selected resources among the plurality of resources based on the role of the electronic device 101. The amount or function related to payment may be to identify operations that should be processed when a payment amount is equal to or smaller than a predetermined amount (for example, 100 dollars) or larger than or equal to a predetermined amount (for example, 1000 dollars).

The payment module 430 may perform payment by using the selected resources. For example, the payment module 430 may temporarily store or process the selected resources only in a secure area (for example, TEE 550 or TEE 920). As another example, the payment module 430 may receive payment authentication information (for example, a Personal Identification Number (PIN) or signature) from a consumer, and transmit the card information and the payment authentication information to the server 106 (for example, an acquirer server 830, a token server 850, an issuer server 860, or a payment server 870) through the communication interface 170 functionally connected to the electronic device 101. The payment module 430 may receive an approval result of the card information and the payment authentication information from the server 106. When the approval result corresponds to “approval”, the payment module 430 may output payment information related to the payment. The payment information may include seller payment information and/or consumer payment information. For example, the payment module 430 may display the seller payment information and/or the consumer payment information on the display 160. Alternatively, the payment module 430 may transmit the consumer payment information to the consumer's electronic device through the communication interface 170. The payment module 430 may store the seller payment information in the secure area.

According to various embodiments of the present disclosure, although it is illustrated that all elements of the electronic device 101 (for example, the processor 120) are included in the electronic device 101, various embodiments are not limited thereto. For example, according to the role, function, or capability of the electronic device 101, at least some of the elements of the electronic device 101 may be distributed to the electronic device 101 and an external electronic device (for example, the first external electronic device 102, the second external electronic device 104, or the server 106).

According to various embodiments, at least some of the execution module 410, the selection module 420, the payment module 430, and the security module 440 may be implemented in software, firmware, hardware, or a combination of two or more thereof. At least some of the execution module 410, the selection module 420, the payment module 430, and the security module 440 may be implemented (for example, executed) by, for example, the processor (for example, the processor 120). At least some of the execution module 410, the selection module 420, the payment module 430, and the security module 440 may include, for example, a module, a program, a routine, sets of instructions, or a process for performing one or more functions.

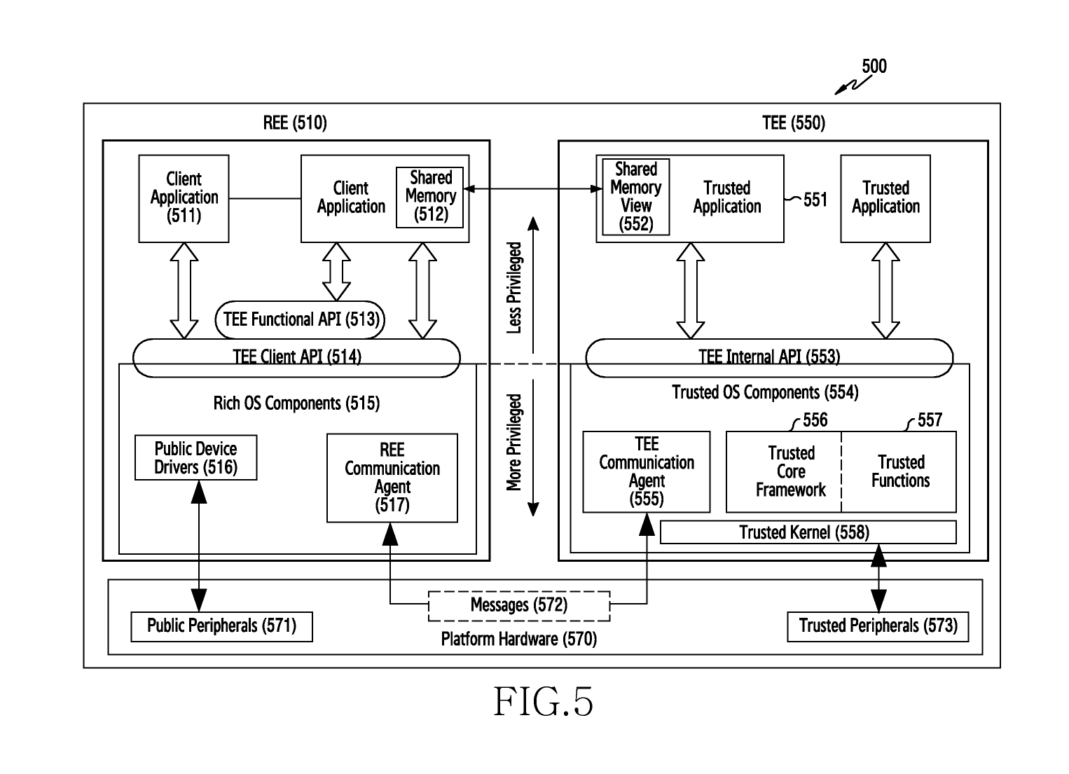

FIG. 5 is a block diagram 500 illustrating an REE and a TEE operated in the electronic device according to one embodiment of the present disclosure.

Referring to FIG. 5, the electronic device 101 may operate an execution environment having a plurality of security levels. A plurality of security environments may include, for example, an REE 510 and a TEE 550. The Rich Execution Environment (REE) 510 may be, for example, a first execution environment having a first security level. The Trusted Execution Environment (TEE) 550 may be, for example, a second execution environment having a second security level different from (for example, higher than) the first security level.

The REE 510 may include, for example, a client application 511, a shared memory 512, a TEE functional API 513, a TEE client API 514, a rich OS component 515, a public device driver 516, or an REE communication agent 517. The client application 511 (for example, the applications 370 or the application programs 147) may include one or more applications for performing a function such as a call, message, payment, alarm, browser, or camera. The client application 511 may include the shared memory 512, and access a shared memory view 552 of the TEE 550 by using the shared memory 512. The shared memory 512 may be a memory which applications of the REE 510 and the TEE 550 can access.

The TEE functional API 513 and/or the TEE client API 514 correspond to APIs which the TEE 550 can access and may perform a function similar to, for example, that of the API 145 or the API 360. The TEE functional API 513 may be an application interface designed to be able to access some services of the TEE 550. The TEE client API 514 may be an interface designed to able to exchange data between applications of the REE 510 and the TEE 550. The rich OS component 515 may include, for example, the public device driver 516 or the REE communication agent 517.

The public device driver 516 may be a system driver for driving a public peripheral device 571 in the REE 510. The REE communication agent 517 may serve to process message communication between the client application 511 and a trusted application 551. The client application 511 may transfer a message 572 from the REE communication agent 517 to a TEE communication agent 555 of the TEE 550 by using the TEE functional API 513 and/or the TEE client API 514. The message 572 may be implemented, for example, to be transferred only to the TEE 550 in hardware. The REE communication agent 517 may receive, for example, a processing result related to the message 572 from the TEE communication agent 555 and transfer the processing result to the client application 511.

The TEE 550 may store, for example, data requiring a relatively high security level in a safe environment and perform a relevant operation. The TEE 550 may operate on the processor 120 of the electronic device 101 based on a trusted hardware structure determined in a manufacturing process of the electronic device 101. The TEE 550 may divide, for example, the application processor or the memory into a normal area and a secure area and operate in the secure area. The TEE 550 may configure software or hardware requiring security, to operate only in the secure area. The electronic device 101 may operate the TEE 550 through a hardware physical change or a software logical change. The TEE 550 may be separated from the REE 510 through a hardware limitation, and operate while being separated in software in the same hardware.

The TEE 550 may include a trusted application 551, a shared memory view 552, a TEE internal API 553, a trusted OS component 554, a TEE communication agent 555, a trusted core framework 556, a trusted function 557, or a trusted kernel 558. The trusted application 551 may include one or more applications for performing a function such as Digital Rights Management (DRM), security, payment, or biometric information. The shared memory view 552 may be a memory space which can access the shared memory 512 of the REE 510.

The trusted application 551 may receive the message 572 from the REE communication agent 517 through the TEE communication agent 557 by using, for example, TEE internal API 553. The TEE internal API 553 may be an interface provided to allow basic software to operate. The TEE communication agent 557 may receive the message 572 and transfer the message 572 to the trusted application 551. The trusted application 551 may perform an operation related to the message 572 and transfer a processing result of the operation to the REE communication agent 517 through the TEE communication agent 557. The trusted OS component 554 may include the TEE communication agent 555, the trusted core framework 556, the trusted function 557, and/or the trusted kernel 558.

The TEE communication agent 555 is one type of framework function APIs and may serve to process safe message communication between the client application 511 and the trusted application 551. The trusted core framework 556 may provide an operating system function such as scheduling, communication, or memory management to be performed by the trusted application 551. The trusted function 557 may provide a trusted function such as a cryptogram. The trusted kernel 558 may be a kernel for driving the TEE 550. Platform hardware 570 is a hardware component for transferring, for example, the message 572 from the RRE communication agent 517 to the TEE communication agent 557. The platform hardware 570 may include a public peripheral device 571 and/or a trusted peripheral device 573. The public peripheral device 571 may communicate with the public device driver 516 of the REE 510. The trusted peripheral device 573 may communicate with the trusted kernel 558 of the TEE 550. The public peripheral device 571 is a general peripheral device located within the electronic device and may be, for example, a gyro sensor or a GPS device. The trusted peripheral device 573 is a security (or cryptogram)-related peripheral device connected to the TEE 550 and may be, for example, a fingerprint sensor, an iris sensor, or a security display.

More privileged and less privileged relate to a right to access the system. The more privileged may refer to a high system access right and the less privileged may refer to a low system access right. For example, when the system right is low, the system access right (for example, file writing or reading) may be limited. The access right may be a concept identical or similar to the access right in the general operating system.

According to an embodiment, the electronic device 101 may include another additional execution environment (for example, a third execution environment) having a third security level, but is not limited thereto.

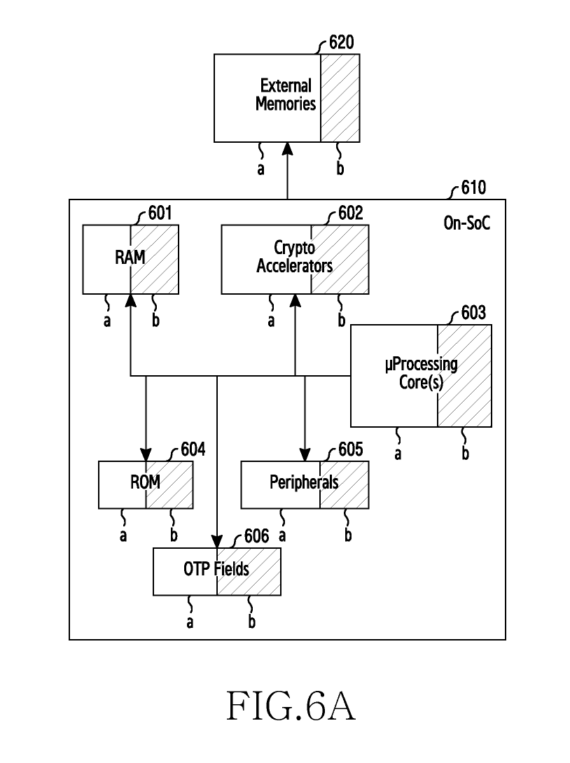

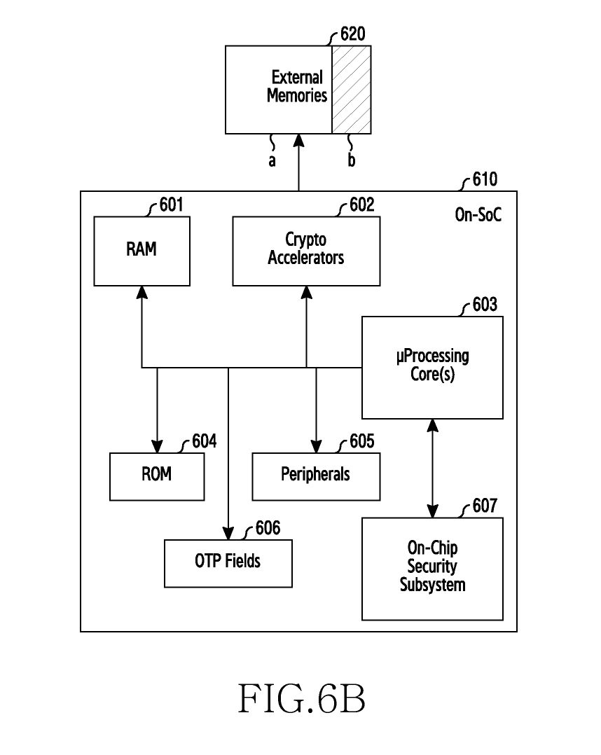

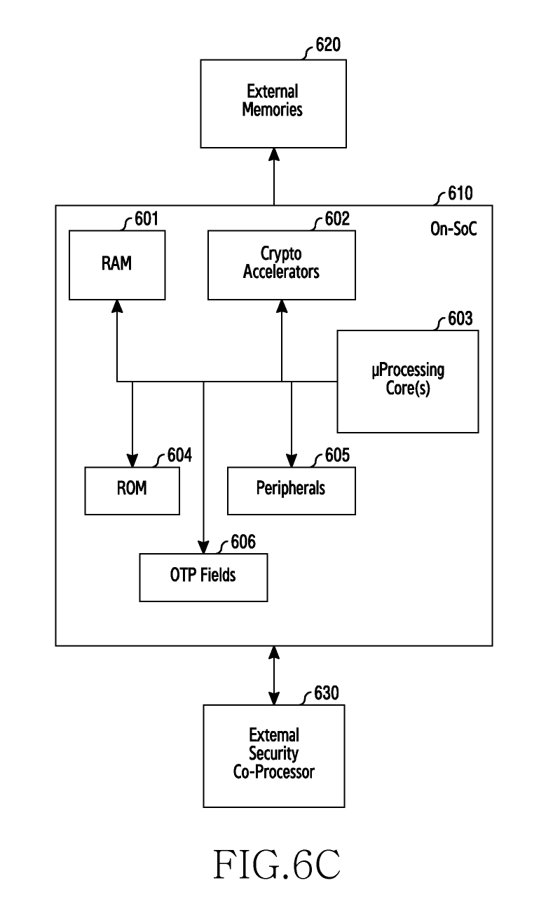

FIGS. 6A to 6C are block diagrams illustrating a hardware structure of the TEE according to one embodiment of the present disclosure.

FIG. 6A illustrates an example (for example, TrustZone (TZ) of ARM) in which one processor (for example, the processor 120) and one memory (for example, the memory 130) are divided into an REE and a TEE in hardware.

Referring to FIG. 6A, a hardware structure of the TEE may include an On-System on Chip (On-SoC) 610 and/or an external memory 620. The On-SoC 610 may include, for example, a Random Access Memory (RAM) 601, a crypto accelerator 602, a micro processing core(s) 603, a Read Only Memory (ROM) 604, a peripheral device 605, or a One time Programmable (OTP) field 606. A processor may be temporally divided into the REE and the TEE in order to operate two or more execution environments. Further, one memory may be divided into an area accessible in the REE and an area accessible in the TEE. Accordingly, the RAM 601, the crypto accelerator 602, the micro processing core 603, the ROM 604, the peripheral device 605, or the OTP field 606 may be divided into an REE area (a) and a TEE area (b).

FIG. 6B illustrates an example in which the processor (for example, the processor 120) for the TEE is implemented in the on-chip type like the processor for operating the REE but implemented as a separate processing core set. The processor for the TEE according to various embodiments may further include an on-chip security subsystem 607 and thus may have a configuration equal or similar to that of the processor (for example, the processor 120). Accordingly, hereinafter, overlapping elements of the processor (for example, the processor 120) will be omitted.

Referring to FIG. 6B, the On-SoC 610 may further include an on-chip security subsystem 607 having one or more processors as in addition to the RAM 601, the crypto accelerator 602, the micro processing core 603, the ROM 604, the peripheral device 605, or the OTP field 606. In this case, the On-SoC 610 may be configured to operate the REE 510 and the on-chip security subsystem 607 may be configured to operate the TEE 550. In FIG. 6B, one memory may be divided into an area (a) accessible in the REE and an area (b) accessible in the TEE like in FIG. 6A.

FIG. 6C illustrates an example in which the processor for the TEE is implemented by a separate chip in hardware and thus is separated from the chip implementing the processor for operating the REE. The processor for the TEE according to various embodiments may further include an external security co-processor 630 and thus may have a configuration equal or similar to that of the processor (for example, the processor 120). Accordingly, hereinafter, overlapping elements of the processor (for example, the processor 120) will be omitted.

Referring to FIG. 6C, the On-SoC 610 may operate the REE 510, and one or more external security co-processors 630 located outside the On-SoC 610 may be configured to operate, for example, the TEE 550.

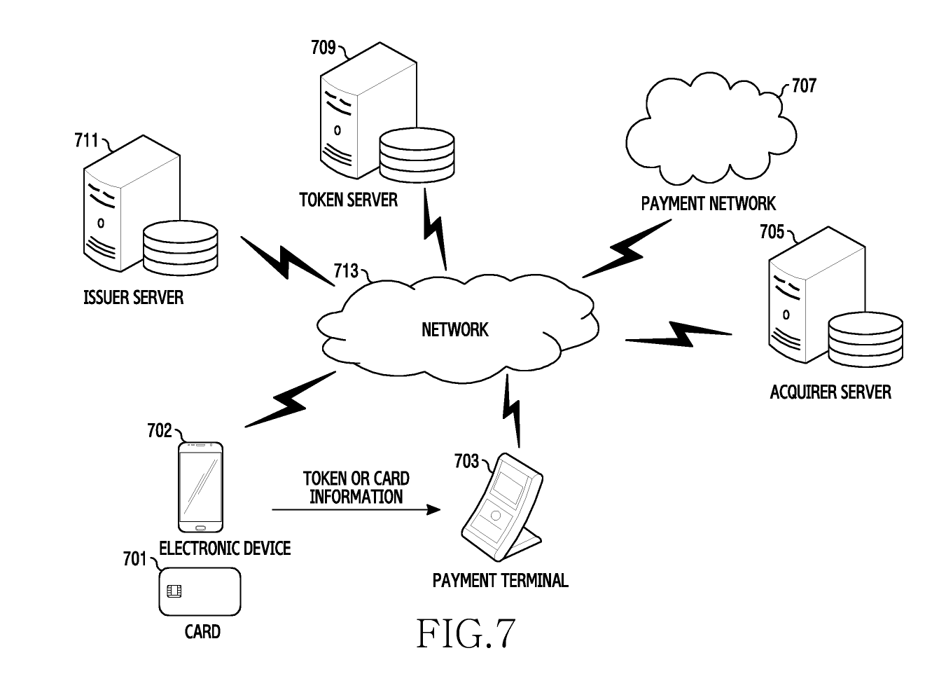

FIG. 7 illustrates a configuration of a payment system according to one embodiment of the present disclosure.

Referring to FIG. 7, the payment system may include, for example, a card 701, an electronic device 702, a payment terminal 703 (for example, POS), a payment network 707, a network 713, or a server (for example, the server 106 of FIG. 1). The server may include, for example, the acquirer server 705, the token server 709, or the issuer server 711. Although the acquirer server 705, the token server 709, and the issuer server 711 are illustrated to be separated from each other in FIG. 7, the acquirer server 705, the token server 709, and the issuer server 711 may be configured as one component according to some embodiments.

The card 701 may include, for example, a magnetic card or an Integrated Circuit (IC) card issued by a card company. The electronic device 702 may transfer at least some of card information (for example, magnetic information or information contained in the IC) to the payment terminal 603. The electronic device 702 (for example, the electronic device 101) may include, for example, a payment application, a payment manager, or a secure area (for example, security module or TEE). According to various embodiments, the electronic device 702 may transfer a token to the payment terminal 603.

The payment terminal 703(for example, POS) may include, for example, a POS information management system. The payment terminal 703 has, for example, a function corresponding to a combination of functions of a casher register and a computer electronic device, and the user may perform a payment function through the payment terminal 703. The acquirer server 705 may include a bank or a financial company that acquires a statement for a card transaction paid in a store (for example, payment terminal 603). For reference, the acquirer server 705 is mentioned in the following drawings and description, but a Value Add Network (VAN) may be used instead of the acquirer server. Alternatively, the acquirer server 705 may include the VAN. The payment network 707 may include, for example, a card network. The token server 709 may generate, for example, a token corresponding to card information of the card 701 and transfer the token to the electronic device 702. Further, the token server 709 may find the card information related to the token in a payment transaction process and inform the payment network 707 of the card information.

The issuer server 711 may include, for example, a bank or a financial company that issues the card 701, and identity the user of the card 701. Further, the issuer server 711 may authenticate the card 701 when performing payment. The issuer server 711 may determine, for example, whether the received card information is effective and transfer a result of the determination to the payment network 707. The network 713 may include a telecommunication network, for example, at least one of a computer network (for example, a LAN or a WAN), the Internet, and a telephone network. According to various embodiments, components of the payment system 600 may transmit/receive data through the network 713.

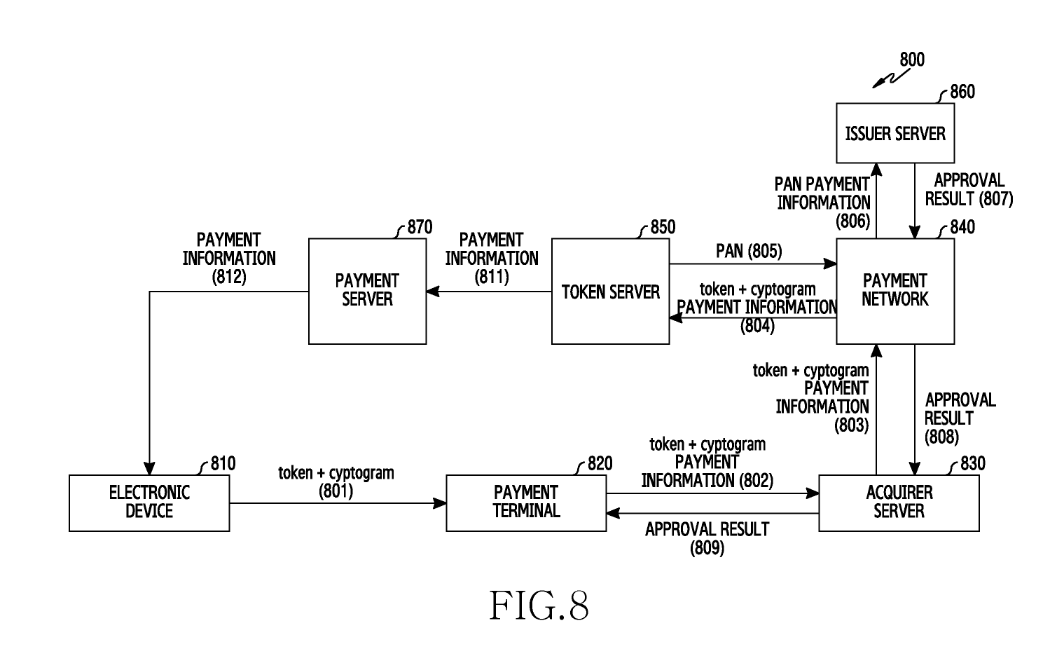

According to various embodiments, a method of performing a payment transaction through the electronic device 702 will be described in detail with reference to FIG. 8.

FIG. 8 illustrates a payment transaction method 800 according to one embodiment of the present disclosure.

Referring to FIG. 8, in operation 801, an electronic device 810 may transfer, for example, a token and/or cryptogram information (for example, cryptogram) to a payment terminal 820 (for example, POS terminal). The token may be stored in, for example, the electronic device 810 and, particularly, in an encrypted area of the electronic device 810. For example, the electronic device 810 may store the token after encrypting the token into a security module or TEE. For example, the electronic device 810 may generate cryptogram information by using a key received from the outside or a key generated by the electronic device 810. The cryptogram information may include a cryptogram.

According to various embodiments, the electronic device 810 may use various communication connections to transfer the token and/or the cryptogram to the payment terminal 820. The communication connections may include, for example, Near Field Communication (NFC), Magnetic Secure Transmission (MST), barcode, or QR code (abbreviated from quick response code).

In operation 802, the payment terminal 820 may transfer, for example, at least one of the token, the cryptogram information, and the payment information to an acquirer server 830. For example, the payment terminal 820 may transfer the token and/or the cryptogram received by the electronic device 710 and the payment information (for example, a payment location, a payment date and time, or a payment amount) acquired by the payment terminal 820 to the acquirer server 830. The payment information may be acquired by the payment terminal 820 or received from an external device, and may include a payment history for which the user has made a request for the payment function. Further, the payment information may include, for example, a payment history performed using a payment system (for example, payment system of FIG. 7).

In operation 803, the acquirer server 830 may transfer, for example, at least one of the token, the cryptogram information, and the payment information to the payment network 840. The acquirer server 830 may receive at least one of the token, the cryptogram information, and the payment information from the payment terminal 820, and transfer at least one of the received token, cryptogram information, and payment information to the payment network 840.

In operation 804, the payment network 840 may transmit, for example, at least one of the token, the cryptogram information, and the payment information to the token server 850. The payment network 840 may include a network related to a card company, and may be, for example, ViSA™, MasterCard™ or Amex™. According to an embodiment, the payment network 840 may include or operate the token server 850.

The token server 850 may receive, for example, at least one of the token, the cryptogram information, and the payment information from the payment network 840. The token server 850 may identify information on the received token. For example, the token server 850 may identify card information (for example, card number (PAN) or expiration date) corresponding to the token by using the token. For example, the token server 850 may identify a PAN corresponding to the issuer server 860 by using information (for example, data) included in the token. The token server 850 may identify, for example, the PAN corresponding to the issuer server 860 and allow the issuer server 860 to receive a payment authentication based on the PAN. According to various embodiments, the token server 850 may identify the PAN by using the received cryptogram. In operation 805, the token server 850 may transfer the PAN to the payment network 840.

The payment network 840 may receive, for example, the PAN from the token server 850. In operation 806, the payment network 840 may transfer the PAN and/or the payment information to the issuer server 860.

The issuer server 860 may receive, for example, the PAN and/or the payment information from the payment network 840. The issuer server 860 may determine a payment approval by using the PAN and/or the payment information. For example, the issuer server 860 may identify whether the PAN and/or the payment information match the information (for example, effective PAN) included in the issuer server 860. The issuer server 860 may check whether there is the PAN, which matches the received PAN in a database that stores the PAN, and identify payment limitation information (for example, payment limit or possibility of overseas approval) related to the matching PAN. The issuer server 860 may determine whether the payment is approved by determining whether the payment information meets the identified payment limitation information. When the PAN and/or the payment information match the information included in the issuer server 860, the issuer server 860 may approve of the payment. Alternatively, when the PAN and/or the payment information do not match the information included in the issuer server 860 (for example, non-effective PAN), the issuer server 860 may reject the payment. The payment rejection may refer to not approving of the payment (for example, non-approval or rejection).

In operation 807, the issuer server 860 may transfer, for example, the approval result (for example, approval or rejection) to the payment network 840.

In operation 808, the payment network 840 may transfer, for example, the approval result to the acquirer server 830. Further, when the approval result corresponds to the approval, the payment network 840 may transfer the payment information to the token server 850.

In operation 809, the acquirer server 830 may transfer the approval result received from the payment network 840 to the payment terminal 820. In operation 811, the token server 850 may transfer, for example, the payment information to the payment server 870.

In operation 812, the payment server 870 may transfer, for example, the payment information to the electronic device 810. For example, the payment server 870 may transfer the payment information to the electronic device 810 by using a designated command (for example, a push message). The payment information may include a payment location, a payment date and time, a payment amount, and an accumulated payment amount.

Although it has been illustrated and described that the acquirer server 830, the token server 850, the issuer server 860, and the payment server 870 are separated from each other, the acquirer server 830, the token server 850, the issuer server 860, and the payment server 870 may be configured as one component according to some embodiments.

According to various embodiments, the electronic device 810 may display the payment information on the display 160. For example, the electronic device 810 may display the payment information through the payment application included in the electronic device 810 or display the payment information through an interface associated with the payment function. The interface associated with the payment function may include a notification bar.

According to various embodiments, the electronic device 810 may display the payment information or information related to the payment (for example, a payment state, a payment history, or an accumulated amount) on the display functionally connected to the electronic device 810. For example, the electronic device 810 may display the payment information or the information related to the payment by using a notification module (for example, the notification manager 349 of FIG. 3) of the electronic device 810. Further, the electronic device 810 may display, for example, the payment information or the information related to the payment through at least one of a notification, an indicator, a state bar, a task bar, an icon, a floating icon, a tile, and a widget or in at least some areas of at least one of a home screen, a lock screen, and a bended display.

According to various embodiments, the electronic device 810 may output a notification, which is relevant to the payment information or the information related to the payment, as a sound through an audio module (the audio module 280 of FIG. 2) and/or a motor (for example, the motor 298 of FIG. 2 or a tactile feedback device (not shown)) functionally connected to the electronic device 810, or a friction display (not shown), or generate a vibration or a haptic effect.

According to various embodiments, a Payment Card Industry (PCI) for agreement on a payment card exists, and the payment terminal 820 should meet requirements by a PIN transaction security (PTS) for a payment transaction. For example, the payment terminal 820 should conform to a counter-mechanism which monitors to physically protect physically sensitive data (for example, card information or signature information) and, when invasion is detected, deletes the sensitive data to prevent data recovery. Further, the payment terminal 820 should conform to requirements in which application execution must be distinguished and another application or Operation System (OS) must not be monitored, collided, or modified. In addition, as the payment terminal 820 performs an authentication when firmware is updated, the firmware should identify a cryptographic authentication when all applications are installed in the corresponding terminal.

The operating system (OS) of the payment terminal 820 may include only software required for an intended function. The OS of the payment terminal 820 should be securely configured and should be executed with minimum rights. In the OS of the payment terminal 820, a security policy executed by the device should not allow a function which is not authenticated or is not required. The OS of the payment terminal 820 should disable a non-required API or commands for supporting a particular function or delete them if possible.

Accordingly, in order to use the electronic device 810 as the payment terminal 820, the aforementioned requirements should be met. According to various embodiments, the electronic device 810 may implement an input such as the PIN as a trusted input, and may safely and directly read a physical signature and the PIN received through the TZ of the touch screen. Alternatively, the electronic device 810 may configure a payment processing mode to be different from a normal mode so that the user can recognize a tone or a screen displayed on the display 160 in the payment processing mode. Hereinafter, an operation method of using the electronic device 810 as the payment terminal 820 will be described in detail.

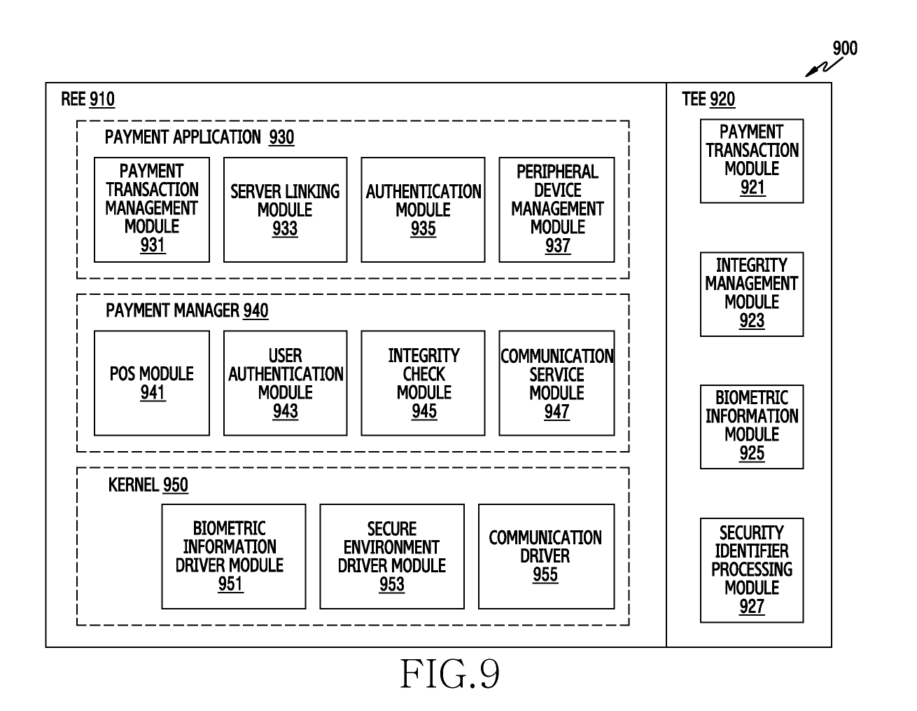

FIG. 9 is a block diagram illustrating a program module of a payment execution environment according to various embodiments.

Referring to FIG. 9, a program module 900 of the payment execution environment may include an REE 910 and a TEE 920. The REE 910 may include, for example, a payment application 930 (for example, the payment application 385), a payment manager 940 (for example, the payment manager 354), and a kernel 950 (for example, the kernel 320) for the payment. According to an embodiment, the payment application 930 may include, for example, a payment transaction management module 931, a server linking module 933, an authentication module 935, and a peripheral device management module 937.

According to an embodiment, the payment transaction management module 931 may read card information from the card 701 and perform an operation for a payment transaction. For example, when a payment transaction is required, the payment transaction management module 931 may activate a transaction mode and read card information of the card 701 to perform the payment transaction. According to an embodiment, the payment transaction management module 931 may display a payment amount and a purchase history to the user through the display 160. According to an embodiment, when performing the payment transaction through the electronic device, the payment transaction management module 931 may perform a user authentication through an authentication module 935. For example, in order to identify whether the user is an owner of the card 701, the authentication module 935 may make a request for inputting the PIN of the card 701 to the owner.

According to an embodiment, the server linking module 933 may be functionally connected to the acquirer server 705 and transfer payment transaction information and/or card information to the acquirer server 705. The acquirer server 705 may transfer, for example, a result of effectiveness of the card information to the server linking module 933. Further, the server linking module 933 may transfer the result of the effectiveness to the payment transaction management module 931.

According to an embodiment, the authentication module 935 may authenticate the card user of the payment information received by the payment transaction module 921. For example, the authentication module 935 may authenticate the card user through a biometric authentication, PIN, or signature. According to an embodiment, the authentication module 935 may perform an operation of identifying a card company that issues the card by using at least one of a token, cryptogram information, and payment information received by the payment transaction module 921. Accordingly, the authentication module 935 may transfer at least one of the identified card company information, the token, the cryptogram information, and the payment information and a transaction history (for example, a transaction amount and store information) to the acquirer server (for example, the acquirer server 705 of FIG. 7) by using the server linking module 933.

According to an embodiment, the authentication module 935 may display a User Interface (UI) for authenticating the card or the user for the payment transaction on the display (for example, the display 160 of FIG. 1). The authentication module 935 may include, for example, a biometric information module. According to an embodiment, the biometric information module may acquire user's biometric information. The user's biometric information may include, for example, information on a fingerprint, iris, facial image, voice, heartbeat, or blood pressure. The biometric information module may acquire the user's biometric information through a sensor module. For example, the biometric information module may acquire a user's fingerprint information through a fingerprint sensor. Alternatively, the biometric information module may acquire a user's iris information through a camera module. The biometric information module may display a UI for acquiring the user's biometric information through the display 160.

According to an embodiment, the peripheral device management module 937 may manage an external device functionally connected to the electronic device 101. The peripheral device management module 937 may include, for example, a card information collection peripheral module and a wearable device module. According to an embodiment, the card information collection device may be a device that reads magnetic information or chip information of the card. According to an embodiment, the wearable device module may output the existence or non-existence of a wired/wireless connection between a wearable device (for example, a clock, a headset, glasses, or ring) and the electronic device 101, and provide a user interface suitable for the user based on the existence of non-existence of the connection. The wired/wireless connection may include various interfaces such as BT, BLE, Wi-Fi, ZigBee, or Z-wave, and may be implemented by applying a particular accessory protocol (Samsung Accessory Protocol (SAP)). The user interface may perform and output a payment process in a state where the electronic device is connected to the wearable device.

The payment manager 940 may include a POS module 941, a user authentication module 943, an integrity check module 945, and a communication service module 947.

The POS module 941 may switch the electronic device 101 for performing the payment transaction to, for example, a mode (for example, POS mode) in which requirements for operating the electronic device 101 as the POS terminal (for example, the payment terminal 820) are met. For example, the POS module 941 may make a request for the integrity check of the electronic device 101 to the integrity check module 945 and receive an integrity check result from the integrity check module 945. For example, when booting the electronic device 101, the integrity check module 945 may perform the integrity check on a system file and store a result value of the integrity check (for example, an integrity flag) in the integrity management module 923. The integrity check module 945 may make a request for identifying whether the electronic device 101 has the integrity to the integrity management module 923 and receive a result value according to the identification. The communication service module 947 may be a module for controlling the payment transaction using short-range communication such as NFC. For example, the communication service module 947 may read information from the card 701 by controlling the NFC module 225 and allow the security module (for example, the security module 440 of FIG. 4) to process the corresponding information through a card processing applet. The card processing applet may include, for example, a trusted application (for example, the trusted application 551 of FIG. 5).

The POS module 941 may identify, for example, whether a user authorized through the user authentication module 943 uses the electronic device 101 as the payment terminal 820. The user authentication may be identified within the electronic device 101 or identified by an external server through the network. When the result of the integrity check has no problem and the user authentication is successful, the POS module 941 may limit a process executed using a white list or limit a network service. Further, the POS module 941 may limit a storage space (for example, the memory 130 of FIG. 1). The white list may include a resource list required for using the electronic device 101 as the payment terminal 820. For example, when the electronic device 101 is used as the payment terminal 820, the selection module (for example, the selection module 420) included in the electronic device 101 may identify the white list. When there are a cellular module (for example, the cellular module 221) and an NFC module (for example, the NFC module 225) among communication modules (for example, the communication modules 220) as the resources included in the white list, the selection module may limit functions of other communication modules (for example, the Wi-Fi module 222, the BT module 223, or the GNSS module 224) except for the cellular module and the NFC module.

According to an embodiment, the user authentication module 943 may inform, through a secure environment driver module 953, the biometric information module 925 of the TEE 920 that an authentication operation is required. Further, for the authentication operation, the POS module 941 may instruct a biometric sensor (for example, the biometric sensor 240I of FIG. 2) to acquire biometric information through the user authentication module 943 and a biometric information driver module 951. In addition, the POS module 941 may transfer an authentication acknowledgment (ACK) message to the biometric information module 925 of the TEE 920 through the user authentication module 943 and the secure environment driver module 953. The biometric sensor 240I may acquire biometric information from the biometric information module 925 of the TEE 920. The biometric information module 925 may compare the stored user's biometric information with the information acquired from the biometric sensor to identify whether the users are the same. The biometric information module 925 may transfer information on whether an authentication is successful to the user authentication module 943 through the secure environment driver module 953 based on the identified information, and the user authentication module 943 may transfer the information to the POS module 941. The POS module 941 and the user authentication module 943 may be configured as one module or configured as separated modules.

According to an embodiment, the secure environment driver module 953 may serve as an interface for transferring from a module within the REE 910 to a module within the TEE 920. For example, in a case of the TrustZone of the ARM which is an embodiment of the TEE 920, when an application processor performs a time sharing operation of the REE 910 and the TEE 920, a separate data route (or path) for transferring a message from the REE 910 to the TEE 920 may be implemented in hardware. In this case, a driver module for accessing the hardware may be the secure environment driver module 953. The secure environment driver module 953 may transfer message for operations of modules within the TEE 920 to modules within the REE 910.

According to an embodiment, a communication driver 955 may be a device for driving NFC.

According to an embodiment, the TEE 920 may include the payment transaction module 921, the integrity management module 923, the biometric information module 925, and/or a security identifier processing module 927. When an operation related to information required to be secured should be performed, the REE 910 can access the TEE 920 only through an API (for example, the TEE functional API 513 and the TEE client API 514) and a driver which can access the TEE 920. The TEE 920 may give limited data on relevant information to the REE 910. The TEE 920 may encrypt stored data through a hardware key (for example, a Device Root Key (DRK)). When there is no separate decryption process, the REE 910 may not analyze data within the TEE 920. An application within the TEE 920 (for example, a trusted application or a payment module) may transfer a message to another external electronic device (For example, the token server 930) of the electronic device 101.

According to an embodiment, the TEE 920 may include a trusted OS and a trusted application. Further, the TEE 920 may include an encryption module related to security and a driver that may collect data in hardware required to be secured. The trusted application may include a payment module. Further, the trusted application may transfer payment information to the outside through the communication module. For example, payment information may be transferred to an MST controller through an MST driver or transferred to an NFC controller through an NFC driver, and then transmitted to the POS module 941.

According to an embodiment, the electronic device 101 (for example, the processor 120) may identify whether the REE 910 is secure and has integrity. The electronic device 101 may store information on whether an image of the REE 910 has integrity in the TEE 920. When the REE 910 supporting the TEE 920 is booted, in a booting order, the TEE 920 may be booted and then the REE 910 may be booted when a boot loader is executed. When the TEE 920 is booted, integrity information of the REE 910 may be identified within the TEE 920, and the integrity may be transferred to the integrity management module 923 or informed the user after the REE 910 is booted. The integrity management module 923 may store and manage a result value of the integrity check by the integrity check module 945. According to an embodiment, when the image of the REE 910 is damaged by hacking or rooting based on the result of the integrity check, the TEE 920 may determine that the integrity has a problem. When the integrity has a problem, the TEE 920 may make the REE 910 inaccessible. For example, when the payment transaction module 931 transfers a message or a command to the TEE 920 through the secure environment driver module 953, the kernel of the TEE 920 may ignore the message or command or reject reception of the message.

According to an embodiment, the payment transaction module 921 may process at least one of the token, cryptogram information, and payment information received through the NFC module. The payment transaction module 921 refers to an Europay Mastercard and Visa (EMV) kernel of an embedded Secure Element (eSE). The payment transaction module 921 may be installed and executed in the TEE 920 or the eSE. According to an embodiment, the payment transaction module 921 may be in a device configured by a separate chip rather than in an area of the TEE 920. For example, the payment transaction module 921 may exist in a Universal IC Card (UICC) embedded SIM (eSIM) or the eSE.

According to an embodiment, the biometric information module 925 may store biometric information of the user using the electronic device 101 and authenticate the user by comparing the biometric information with information received from the biometric sensor 240I. The biometric information module 925 may include a fingerprint information module and/or an iris information module. The biometric information module 925 may collect biometric information from the biometric sensor 240I. For example, an authentication module of the payment application may transfer a message for collecting the biometric information to the biometric information driver module 951 through the biometric information module 925. The biometric information driver module 951 may transfer the message to the biometric sensor 240I.

The payment application may display contents for authenticating the user's biometric information on the display 160. At this time, an input location for the biometric sensor 240I is also displayed on the display 160, so that the user can bring a part of the user's body into contact with the input location of the biometric sensor 240I. The biometric sensor 240I may collect biometric information and transfer the collected biometric information to the biometric information module 925. The biometric information module 925 may compare the collected biometric information with the stored user's biometric information and transfer information on whether the user authentication is successful to the authentication module of the payment application through a biometric information management module of the REE 910 through the secure environment driver module 953. The payment application may display the information on whether the authentication is successful on the display 160. The user's biometric information may be stored in the TEE 920 or the REE 910, or the security module 236 (for example, eSE) in an encrypted state.

According to an embodiment, the security identifier processing module 927 may acquire an authentication, which the electronic device 101 requires or is related to payment, through a user input. For example, the user input related to the authentication may be card information or the PIN. For example, the card information may include at least one of a PAN, an expiration date, and a CVV. Further, the card information may be a chip PIN or an Automated Teller Machine (ATM) PIN. The security identifier processing module 927 may be displayed in the form of an application. A graphic library required for displaying the application of the security identifier processing module 927 on the display 160 may be driven in the TEE 920. The graphic library stored in the TEE 920 may be different from a graphic library in the REE 910. The security identifier processing module 927 may perform the user authentication by an input value of the PIN and transfer a result thereof to the payment transaction management module 931 through the payment transaction module 921.

According to various embodiments, although it is illustrated that all elements of the electronic device 101 are included in one electronic device, various embodiments are not limited thereto. For example, according to the role, function, or capability of the electronic device 101, at least some of the elements of the electronic device 101 may be distributed to the electronic device 101 and an external electronic device (for example, the first external electronic device 102, the second external electronic device 104, or the server 106 of FIG. 1). For example, the POS module 941 and/or the user authentication module 943 of the electronic device 101 may be included in the electronic device 101, and the integrity check module 945 and/or the communication service module 947 may be included in the external electronic device.

Various embodiments of the present disclosure are not limited thereto, and the payment application 930, the payment manager 940, the kernel 950, or the TEE 920 may be included in various areas of the electronic device 101.

According to various embodiments, at least some of the POS module 941, the integrity check module 945, the payment transaction module 921, and the integrity management module 923 may be implemented in software, firmware, hardware, or a combination of two or more thereof. At least some of the POS module 941, the integrity check module 945, the payment transaction module 921, and the integrity management module 923 may be implemented (for example, executed) by, for example, the processor (for example, the processor 120). At least some of the POS module 941, the integrity check module 945, the payment transaction module 921, and the integrity management module 923 may include, for example, a module, a program, a routine, sets of instructions, or a process for performing one or more functions.

An electronic device including a plurality of resources according to various embodiments may include a communication interface, a display, a memory, and a processor functionally connected to the memory, wherein the processor may be configured to perform operations, the operations including an operation of executing an application for performing payment, an operation of selecting one or more resources to be used for the payment among the plurality of resources at least based on the execution, and an operation of performing the payment through the application by using the one or more resources.

The processor according to various embodiments may be configured to select the one or more resources based on a capability of the electronic device, a role of the electronic device, an amount or a function related to the payment, or a combination thereof.

The processor according to various embodiments may be configured to further select one or more resources other than the resources among the plurality of resources based on the role of the electronic device.

The electronic device according to various embodiments may include a portable terminal, and the processor may be configured to transmit or receive payment information related to the payment to or from an external electronic device and perform the payment.

The processor according to various embodiments may further include a security module and may be configured to perform the payment at least based on authentication information related to the payment acquired from the security module.

The resources according to various embodiments may include hardware functionally connected to the electronic device, software executed through the hardware, a command executed through a processor included in the electronic device, or a combination thereof.

The electronic device according to various embodiments may include a portable terminal, and the processor may be configured to perform an operation of identifying integrity information of the electronic device, and an operation of making a request for authentication information related to the payment based on the identification.

The processor according to various embodiments may be configured to perform an operation of identifying the authentication information, an operation of executing the performing of the payment comprises performing the payment through the application while the payment processing mode is executed.

The processor according to various embodiments may be configured to further perform an operation of determining effectiveness of the input information, and an operation of, when the information is not effective, limiting execution of a function corresponding to the information.

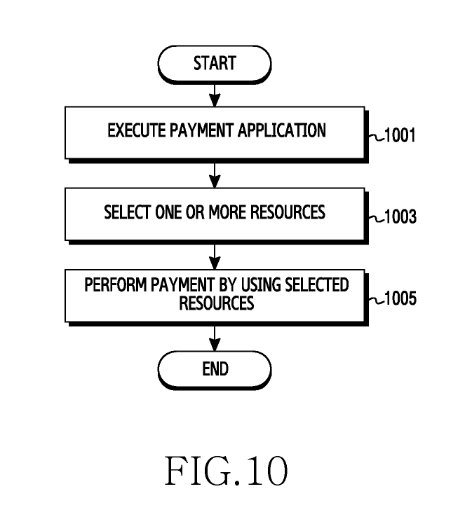

FIG. 10 is a flowchart illustrating a method of providing a payment service by an electronic device according to one embodiment of the present disclosure.

Referring to FIG. 10, in operation 1001, the electronic device 101 (for example, the processor 120) may execute a payment application. When the user selects (or touches) the payment application displayed on the display 160 of the electronic device 101 in an icon type, the processor 120 may execute the payment application. Alternatively, when the user inputs a preset gesture or voice to execute the payment application, the processor 120 may execute the payment application. The payment application may be to use the electronic device 101 as the payment terminal 820.

According to various embodiments, when the payment application is executed, the processor 120 may perform an integrity check of the electronic device 101 and a user authentication, and then enter a payment processing mode. The integrity check and the user authentication will be described below in detail through FIG. 11. The payment processing mode may be distinguished from a mode (for example, normal mode) in which the electronic device 101 is not used as the payment terminal 820. The payment processing mode is to use the electronic device 101 as the payment terminal 820 and may allow only some operations of the electronic device 101. For example, the payment processing mode may allow only operations for payment and block all operations irrelevant to payment. Hereinafter, operation 1003 and operation 1005 may be operations performed after the entry into the payment processing mode.

In operation 1003, the processor 120 may select, for example, one or more resources. When the processor 120 acquires card information (for example, a card number (PAN), an expiration date, and a CVV) from the card 701 or another electronic device (for example, the electronic device 102 or 104 of FIG. 1), the processor 120 may select one or more resources required for payment. According to various embodiments, the processor 120 may select the one or more resources based on a capability of the electronic device 101, a role of the electronic device 101, an amount or function related to the payment, or a combination thereof. The capability of the electronic device 101 may include a hardware capability and a software capability of the electronic device 101. For example, the capability of the electronic device 101 may be a storage size, a used amount, a processing speed, a screen size, or a resolution.

According to an embodiment, when a memory size (for example, the storage size) of the electronic device 101 for storing external data (for example, payment information) is smaller than a predetermined size (for example, 1 Gbyte), the processor 120 may limit access to the memory (for example, the memory 230) among resources included in the electronic device 101. For example, the processor 120 may smoothly perform functions of the payment terminal by limiting the access to the memory.

According to an embodiment, when there are many commands performed by the processor 120 of the electronic device 101, that is, when the used amount of the electronic device 101 is high, the processor 120 may limit the access to the processor (for example, the processor 210) used for data processing. For example, the processor 120 may be configured to not perform anything except for a payment-related command.

According to an embodiment, when the processing speed of the command performed by the electronic device 101 is lower than a predetermined speed, the processor 120 may limit access to an application (for example, the media player 382 or the camera 376) having a high used amount of the processor 120 among the resources included in the electronic device 101.

According to an embodiment, the resources included in the electronic device 101 may be selected based on the screen size or the resolution supported by the electronic device 101. For example, the electronic device 101 may include a plurality of displays (for example, the display 260) and select one of the plurality of displays. For example, the electronic device 101 may select a display having a screen size or a resolution identical/similar to that related to a user interface of the payment application among the plurality of displays.

According to an embodiment, the role of the electronic device 101 may include operations which the electronic device 101 should perform to process the payment. For example, when the number of types of payment processing modes is plural, the operations which the electronic device 101 should perform to process the payment may vary depending on the type of payment processing mode. According to various embodiments, the processor 120 may further select one or more other resources as well as the selected resources among the plurality of resources based on the role of the electronic device 101.

The amount or function related to payment may be to identify operations should be processed when a payment amount is equal to or smaller than a predetermined amount (for example, 100 dollars) or larger than or equal to a predetermined amount (for example, 1000 dollars). For example, when the payment amount is equal to or smaller than 100 dollars, an owner of the card 701 (for example, consumer) may perform payment without any additional authentication. Alternatively, when the payment amount is larger than or equal to 1000 dollars, the additional authentication of the consumer may correspond to acquisition of signature or biometric information along with a password input.

In operation 1005, the processor 120 may perform payment by using, for example, the selected resources. The processor 120 may temporarily store the selected resources in a secure area (for example, the TEE 550 or the TEE 920) or process the selected resources and transmit or receive the resources to or from an external device (for example, the electronic device 102 or the server 106). For example, the processor 120 may receive payment authentication information (for example, PIN or signature) from the consumer and transmit the card information and the payment authentication information to the server 106 (for example, the acquirer server 830, the token server 850, the issuer server 860, and the payment server 870). The server 106 may determine effectiveness of the card information and the payment authentication information. The server may approve of the authentication when the card information and the payment authentication information are effective and may reject the authentication when the card information and the payment authentication information are not effective. The server 106 may transmit an approval result (for example, approval or rejection) to the electronic device 101.

The processor 120 may receive the approval result of the card information and the payment authentication information from, for example, the server 106. When the approval result corresponds to the “approval”, the processor 120 may output payment information related to the payment. The payment information may include seller payment information and/or consumer payment information. For example, the processor 120 may display the seller payment information and/or the consumer payment information on the display 160. Alternatively, the processor 120 may transmit the consumer payment information to the electronic device of the consumer. The processor 120 may store the seller payment information in the secure area.

FIG. 11 is a flowchart illustrating a method of entering a payment processing mode by an electronic device according to one embodiment of the present disclosure.

Referring to FIG. 11, in operation 1101, the electronic device 101 (for example, the processor 120) may execute, for example, a payment application. The user may select the payment application displayed on the screen in an icon type or input a preset gesture or voice for executing the payment application, so as to execute payment application.

In operation 1103, for example, when the payment application is executed, the processor 120 may perform an integrity check of the electronic device 101. The integrity check may be to identify whether a program within the electronic device 101 has changed without permission or a malicious code such as Malware has been installed in the electronic device 101. For example, the integrity check module 945 may identify an integrity flag managed by the integrity management module 823 by calling the integrity management module 923 of the TEE 920. According to an embodiment, the integrity check may be executed even when power is applied to the electronic device 101. In booting, the processor 120 may perform the integrity check on a system file. For example, the integrity check of the system file may be to check a hash for a ROM OS or an electronic signature value. Alternatively, the integrity check may be to check a forgery file or whether rooting is made.

According to an embodiment, the integrity check module 945 may reflect a result of the check in the integrity flag of the integrity management module 923. According to an embodiment, the integrity management module 923 may periodically perform the integrity check of the system file after the complete booting, or additionally perform the integrity check right before executing the payment program.

In operation 1105, the processor 120 may perform, for example, a user authentication. In order to execute the payment processing mode, the user authentication may be to determine whether the user using the electronic device 101 is an allowed user. The processor 120 may store information related to the user authentication in the secure area. The processor 120 may make a request for inputting a user ID or a password, or biometric information (for example, a fingerprint, iris, or face) for the user authentication. The user may input the user ID or the password or bring his/her finger into contact with the electronic device 101 to fingerprint recognition according to the request for the user authentication.

In operation 1107, for example, when the user authentication is completed, the processor 120 may execute a POS mode (for example, the payment processing mode). When the input user ID and password are the same as the user authentication information stored in the secure area, the processor 120 may determine that the user authentication has been completed. According to various embodiments, when executing the payment processing mode, the processor 120 may stop all processes except for the process required for the payment. The executable process may include, for example, a process for driving a TEE environment, a process for the integrity check, a screen process for showing a basic screen, a communication process for communicating with an external server, an NFC process, and a phone process.

The processor 120 may limit, for example, an available communication module. For example, the processor 120 may allow only a communication function related to a payment transaction such as Wi-Fi, cellular (3G/4G) communication, GPS, and/or NFC to be used. The processor 120 may limit access such that access only to a predetermined Uniform Resource Locator (URL) is allowed through the limited communication module. For example, when the payment processing mode is executed, the processor 120 may block a URL (for example, http://www.samsung.com), which can be accessed in the normal mode, so that access to the URL is not possible. In contrast, the processor 120 may allow access to a URL (for example, http://A.bank.com) for transferring payment transaction data (for example, card information and payment approval information).

According to various embodiments, the processor 120 may limit user's access to the memory. For example, the processor 120 may allow only a memory read right and block storage of a PIN input generated during the payment transaction or card data in the electronic device 101. According to another embodiment, the processor 120 may block a connection of an external memory to the electronic device 101 and block storage of information in the external memory.

According to an embodiment, NFC may be changed to operate only in a reader mode. For example, in using NFC in the electronic device, the processor 120 may limit to operate only in a card reader mode defined in an EMV standard. A program for operating only in the EMV card reader mode may be installed in the payment transaction module 921 of the TEE 920.

According to an embodiment, the processor 120 may display the payment processing mode on the screen to inform the user that the payment processing mode is being executed. For example, the processor 120 may change a screen brightness, color, or tone of the display 160, display a line at an outer part of the display 160, display a notification bar, or process a predetermined area of the display 160 to be translucent.

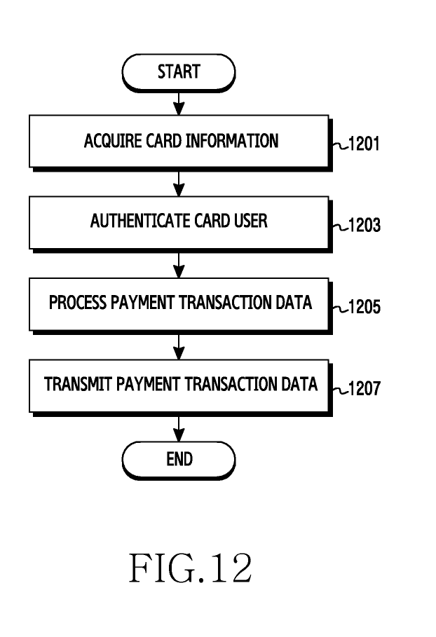

FIG. 12 is a flowchart illustrating a payment method of an electronic device according to one embodiment of the present disclosure.

Referring to FIG. 12, in operation 1201, the electronic device 101 (for example, the processor 120) may acquire, for example, card information. The processor 120 may read some information stored in an IC chip of the card 701 through NFC and transmit the information to the payment transaction module 921. Some information may include information on how to process a user authentication for payment. For example, the authentication of the card user may be performed through a PIN or signature. According to an embodiment, when a payment amount is equal to or smaller than a predetermined value (for example, equal to or smaller than $100), the user authentication may be omitted.

In operation 1203, the processor 120 may authenticate, for example, the card user. According to an embodiment, the security identifier processing module 927 may configure a user interface on the screen to receive the PIN, CVV number, or signature. The user interface may be configured as a Trusted User Interface (TUI). The PIN, CVV number, or signature input through the security identifier processing module 927 may be transferred to the payment transaction module 921 and used to determine whether the authentication is successful.

According to an embodiment, when the payment transaction module 921 receives the PIN, the payment transaction module 921 may identify whether the received PIN matches the PIN set on the IC chip and, when the PINS match each other, acquire payment transaction data from the IC chip of the card 701. Accordingly, in order to acquire the payment transaction data from the IC chip existing in the card 701, the payment transaction module 921 may perform an operation of acquiring information by additionally using NFC. For example, the payment transaction module 921 may further require an additional operation after the authentication. For example, the payment transaction module 921 may acquire card information based on an operation of tagging the card 701 on the electronic device 101 by the user.

In operation 1205, the processor 120 may process, for example, the payment transaction data. The payment transaction data may include a card number, a token, an expiration date, a card owner name, and a CVV. The payment transaction module 921 may identify information required for payment among the payment transaction data and prepare transmission of the information. The processor 120 may encrypt the payment transaction data to transmit the payment transaction data.

In operation 1207, the processor 120 may transmit, for example, the processed payment transaction data. The communication service module 947 and/or the server linking module 933 may transmit the payment transaction data to the server 106.

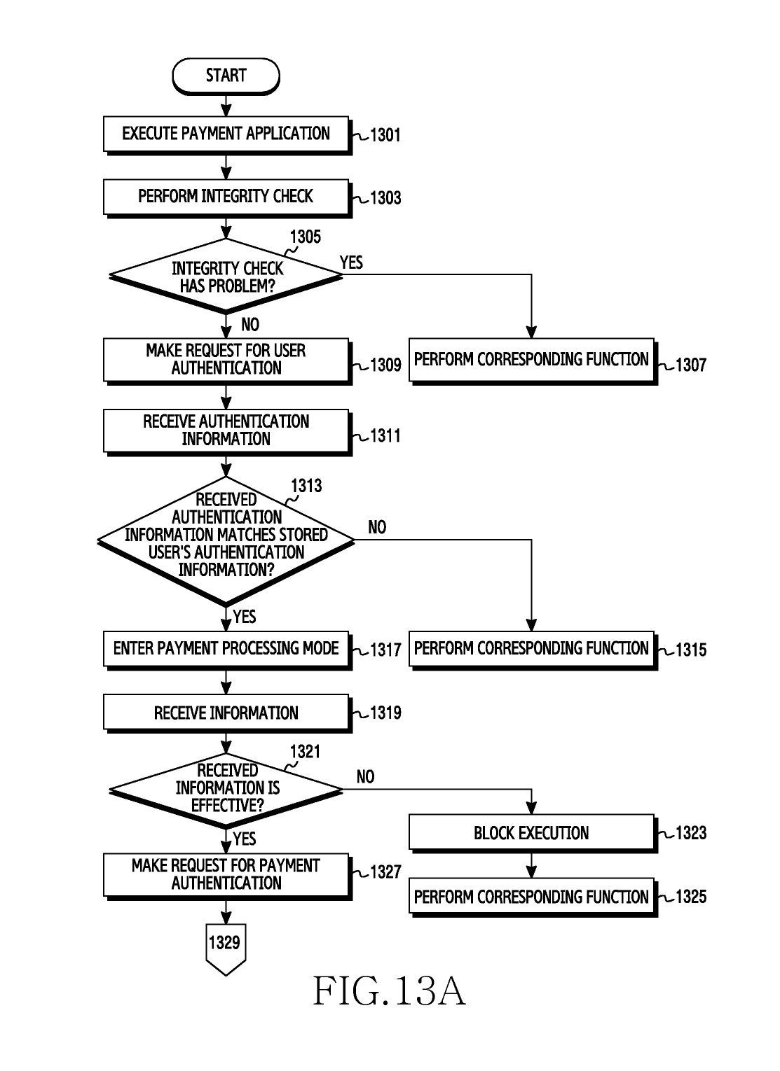

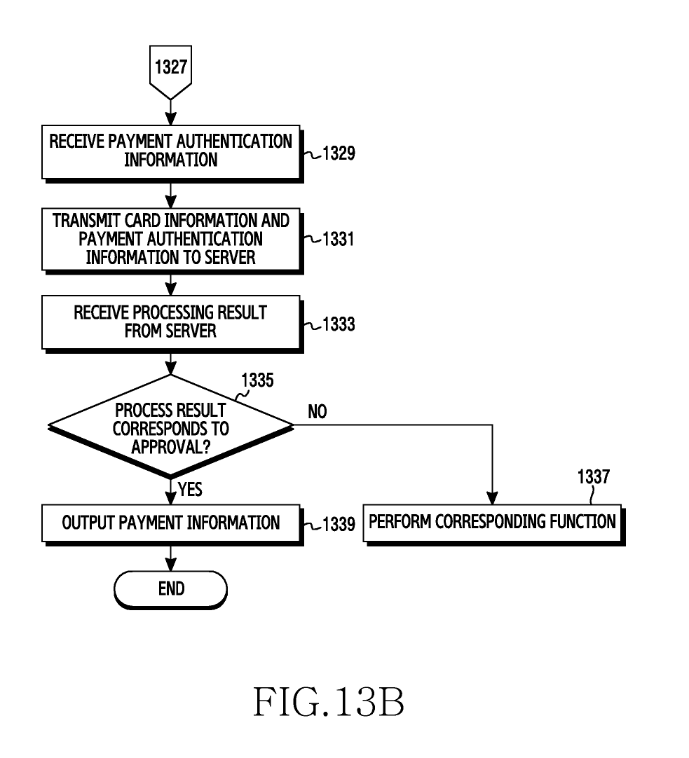

FIGS. 13A and 13B are flowcharts illustrating an operation method of an electronic device according to one embodiment of the present disclosure.

Referring to FIG. 13A, in operation 1301, the electronic device 101 (for example, the processor 120) may execute, for example, a payment application. According to various embodiments, the processor 120 may execute the payment application according to a user input. The user input may be selecting an icon of the payment application or a preset touch, gesture, or voice.

According to various embodiments, when a preset condition is met without the user input, the processor 120 may execute the payment application. For example, the preset condition may be configured by the user like an alarm or configured based on a use history of the electronic device 101. When a current location at 11 a.m. corresponds to a configured location (for example, Nonhyeon-dong, Gangnam-gu, Seoul), the user may configure to automatically execute the payment application.

Alternatively, in a case where the user mainly uses the electronic device 101 in a payment processing mode at the configured location from 11 a.m. to 11 p.m., and current location at 11 a.m. corresponds to the configured location (for example, Nonhyeon-dong, Gangnam-gu, Seoul), the user may configure to automatically execute the payment application.

According to various embodiments, when the payment application is executed, the processor 120 may determine whether an execution condition is met. The execution condition may be configured by the user like an alarm or configured based on a use history of the electronic device 101. When the execution condition configured by the user corresponds to a case where the current location is within a configured radius (for example, Nonhyeon-dong, Gangnam-gu, Seoul) from 11 a.m. to 11 p.m, the payment application may be allowed to be executed. Alternatively, the processor 120 may configure the execution condition to be similar to the user configuration based on the user history. The processor 120 may execute the payment application when the execution condition is met, and may not execute the payment application when the execution condition is not met.

In operation 1303, for example, when the payment application is executed, the processor 120 may perform an integrity check. The integrity check may be to identify whether a program within the electronic device 101 has changed without permission or a malicious code such as malware has been installed in the electronic device 101. According to an embodiment, the processor 120 may perform the integrity check when power is applied (booted) to the electronic device 101. The processor 120 may perform the integrity check periodically or at a preset time.

In operation 1305, the processor 120 may determine, for example, whether there is a problem based on a result of the integrity check. The processor 120 may operation 1309 when there is no problem based on the result of the integrity check, and perform operation 1307 when there is the problem based on the result of the integrity check.

In operation 1307, the processor 120 may perform a corresponding function to operation 1305. For example, the processor 120 may display the result of the integrity check on the display 160. The user may identify the displayed result of the integrity check and make a request for a re-check. When the re-check is requested, the processor 120 may perform the integrity check once more. Alternatively, the processor 120 may inform that the payment application cannot be executed and end the payment application.

When the integrity check has no problem in operation 1305, the processor 120 may perform operation 1309. For example, the processor 120 may make a request for a user authentication. The processor 120 may store in advance information related to the user authentication in the secure area (for example, TEE or white list). The user authentication is to determine whether the user using the electronic device 101 is an allowed user. The processor 120 may configure and display a user interface for inputting a user ID or a password for the user authentication. The user interface may include an input item and a keypad for inputting the user ID or the password. Alternatively, the processor 120 may configure or display a user interface for inputting biometric information (for example, fingerprint, iris, or face). The user interface may output a phrase, an image, or a voice for informing of a place where a fingerprint sensor and a camera are located.

According to various embodiments, the user authentication may be the same as or different from unlocking of the electronic device 101 (for example, releasing a lock screen) or information (for example, password) input after booting of the electronic device 101. For example, when only one user uses the electronic device 101, the user authentication may be the same as the user authentication that unlocks the electronic device 101. Alternatively, when one or more users use the electronic device 101, the user authentication may be different from the user authentication that unlocks the electronic device 101.

In operation 1311, the processor 120 may receive, for example, authentication information through the user interface. The user may input the user ID into the input item of the user ID and input the password into the input item of the password through the keypad displayed in the user interface. When information is input into each of the input items, the processor 120 may receive the input information as the authentication information. Alternatively, the user may input his/her fingerprint by bringing his/her finger into contact with the guided part of the user interface where a fingerprint sensor is located. The processor 120 may recognize the fingerprint input into the fingerprint sensor.

In operation 1313, the processor 120 may determine, for example, whether the received authentication information matches the user's authentication information stored in the secure area. The processor 120 may perform operation 1317 when the authentication information matches, and perform operation 1315 when the authentication information does not match.

In operation 1315, the processor 120 may perform, for example, a corresponding function to operation 1313. For example, the processor 120 may display a result of the user authentication on the display 160. The processor 120 may display a message informing that the authentication information does not match. The processor 120 may include a re-authentication or a cancel button along with the message. When the user selects the re-authentication button, the processor 120 may re-perform operation 1309 and operation 1311. In the re-performance of the authentication, the number of re-performances (for example, three times or five times) may be determined according to user settings or settings of the electronic device 101. The processor 120 may count the number of re-performances and, when the counted number of re-performances exceeds the number of re-performances, end the operation without the re-authentication. Alternatively, when the user selects the cancel button, the processor 120 may end the operation. Alternatively, the processor 120 may display a result of the user authentication and end the operation.

For example, when the authentication information matches, the processor 120 may enter a payment processing mode (for example, POS mode) in operation 1317. When the authentication information matches, the processor 120 may determine that the user authentication has been completed and enter the payment processing mode. The payment processing mode is distinguished from the normal mode of the electronic device 101 and may be a mode in which all processes except for a process required for payment are limited. The executable processor may include, for example, a process for driving a TEE environment, a process for the integrity check, a screen process for showing a basic screen, a communication process for communicating with an external server, an NFC process, and a phone process.

According to another embodiment, when the processor 120 enters the payment processing mode, the processor 120 may change a home screen to be distinguished from the normal mode. For example, the home screen of the normal mode may display all applications installed in the electronic device 101 by the user in an icon type, but the home screen of the payment processing mode may display applications related to payment in an icon type. Alternatively, the home screen of the payment processing mode may have a screen brightness, color, and tone changed from those of the home screen of the normal mode. Alternatively, the home screen of the payment processing mode may display a line on an outer part of the display 160. The home screen of the payment processing mode may display a notification bar (for example, execution of the payment processing mode) or display a predetermined area of the display 160 to be translucent.

In operation 1319, the processor 120 may receive information. The information may include card information and a user input. When the card 701 contacts or is tagged on (located close to) the electronic device 101, the processor 120 may acquire the card information (for example, a card number (PAN), an expiration date, and a CVV) from the card 701. Alternatively, the processor 120 may acquire the card information by scanning a barcode (or QR code) from the card 701. When the card information is acquired, the processor 120 may temporarily store the card information in the secure area. The user input may select an icon displayed on the display 160 or make a request for executing a function in the executed application.

In operation 1321, the processor 120 may determine, for example, whether the input information is effective. The processor 120 may perform operation 1327 when the input information is effective, and perform operation 1323 when the input information is not effective.

In operation 1323, the processor 120 may block, for example, execution of a function (for example, application) for the information reception. For example, when the input information (for example, user input) makes a request for a non-allowed communication connection, the processor 120 may block the communication connection. Alternatively, when the input information (for example, user input) makes a request for access to a non-allowed URL, the processor 120 may block the access to the URL.

In operation 1325, the processor 120 may display, for example a blocking message on the display 160. The blocking message may be a user interface informing that the requested function cannot be performed. The processor 120 may include a payment processing mode end or a cancel button along with the message. When the user selects the payment processing mode end button, the processor 120 may end the payment processing mode and return to the normal mode. When the user selects the cancel button, the processor 120 may return to operation 1317. That is, the processor 120 may wait for information reception in a state where the payment processing mode is executed. When returning to operation 1317, the number of cancellations (for example, three times or five times) may be determined according to user settings or settings of the electronic device 101. The processor 120 may count the number of cancellations. When the counted number of cancellations exceeds the number of cancellations, the processor 120 may end the payment processing mode and return to the normal mode. Alternatively, when the user selects the cancel button, the processor 120 may end the operation. Alternatively, the processor 120 may display the blocking message and end the operation.

In operation 1327, the processor 120 may make a request for, for example, a payment authentication. The payment authentication corresponds to a request made to an owner of the card or a purchaser who purchases a product or a service, and the processor 120 may make a request for inputting a card password or signature. The processor 120 may configure and display a user interface for receiving the card password or signature. When the card password is input, an input field and a number keypad may be displayed in the user interface. When the signature is input, an input field for receiving a writing input may be displayed in the user interface.

Referring to FIG. 13B, in operation 1329, the processor 120 may receive, for example, payment authentication information. When the password is input, the processor 120 may process numbers input into the input field to be shown as special characters immediately when the numbers are input. Accordingly, characters displayed in the input field may be special characters such as * or # rather than numbers. When the signature is input, the processor 120 may recognize a writing input made into the input field.

In operation 1331, the processor 120 may transmit, for example, the card information and the payment authentication information to the server 106. The processor 120 may temporarily store the card information and the payment authentication information in the secure area, encrypt the card information and the payment authentication information, and transmit the encrypted card information and payment authentication information to the server 106.

The server 106 may be at least one of the acquirer server 830, the token server 850, the issuer server 860, and the payment server 870. When the server 106 is at least one of the acquirer server 830, the token server 850, the issuer server 860, and the payment server 870, the server 106 may perform an operation for payment processing performed in FIGS. 7 and 8. The server 106 may be one server configured by all of the acquirer server 830, the token server 850, the issuer server 860, and the payment server 870. In this case, the server 106 may perform all operations for payment processing performed in FIGS. 7 and 8 and then transmit a processing result (for example, approval or rejection) to the electronic device 101.

According to various embodiments, the server 106 may be an online shopping server. For example, in conventional arts, when the user makes a request for paying for a product in the online shopping server, the online shopping server might make a request for inputting card information in a webpage. However, in the present disclosure, when the user makes a request for paying for a product in the online shopping server, the online shopping server may make a request for inputting a phone number instead of inputting the card information. The online shopping server may transmit a message for acquiring the card information to the electronic device 101 having the input phone number. The message may include a URL for inputting the card information. When the message is received, the processor 120 may perform an operation for entering the payment processing mode. Alternatively, when the processor 120 receives the message after entering the payment processing mode, the processor 120 may acquire card information and payment approval information. The processor 120 may transfer the card information and the payment approval information to the online shopping server. Accordingly, the user may pay for the product of the online shopping server by simply bringing the card 701 into contact with the electronic device 101 of the user or tagging the card 701 on the electronic device 101.

In operation 1333, the processor 120 may receive, for example, a result of the processing from the server 106.

In operation 1335, the processor 120 may determine whether the received processing result corresponds to approval. The processor 120 may perform operation 1339 when the processing result corresponds to the approval, and perform operation 1337 when the processing result corresponds to rejection.

In operation 1337, the processor 120 may perform, for example, a function corresponding to non-approval. For example, the processor 120 may display the processing result on the display 160. The processor 120 may display a message informing of non-approval such as approval rejection, limit excess, non-approved card, or card loss. The processor 120 may include a re-payment or a cancel button along with the message. When the user selects the re-payment button, the processor 120 may re-perform operation 1327 and operation 1329. In the re-performance, the number of re-performances (for example, three times or five times) may be determined according to user settings or settings of the electronic device 101. The processor 120 may count the number of re-performances and, when the counted number of re-performances exceeds the number of re-performances, end the operation without the re-payment. Alternatively, when the user selects the cancel button, the processor 120 may end the operation. Alternatively, the processor 120 may display the processing result and end the operation.

According to various embodiments, when the processor 120 detects a call connection (originating request or call reception) during the payment processing operation, the processor 120 may block the call connection. For example, when an application related to the call is selected during the payment processing operation, the processor 120 may block execution of the call application. The processor 120 may display a call blocking message. Alternatively, when the processor 120 detects reception of a call from a counterpart's electronic device during the payment processing operation, the processor 120 may block the received call. After blocking the call, the processor 120 may transmit a call blocking notification message (for example, I cannot answer the phone right now) to the counterpart's electronic device. After the payment is completed, the processor 120 may display a call reception message during payment. The call reception message during payment may include a counterpart's phone number and a call reception time.

According to various embodiments, when the processor 120 detects a call connection (originating request or call reception) during the payment processing operation, the processor 120 may determine whether the counterpart's phone number is included in a phone book or call logs (for example, one of outgoing call logs, incoming call logs, and missed call logs) of the memory 130. When the counterpart's phone number corresponds to the phone number included in the phone book or the call logs, the processor 120 may allow call reception or transmission. Alternatively, when the counterpart's phone number does not correspond to the phone number included in the phone book or the call logs, the processor 120 may block call reception or transmission. When the call is blocked, the processor 120 may transmit a call blocking notification message to the counterpart's electronic device and, after the payment is completed, display the call reception message during payment.

According to various embodiments, when the processor 120 detects a call connection (originating request or call reception) during the payment processing operation, the processor 120 may determine whether the counterpart's phone number corresponds to a set phone number. The set phone number may be set by the user or set by the electronic device 101. For example, the set phone number may be a phone number stored in the phone book or a phone number of a card company or a financial company. When the counterpart's phone number matches the set phone number, the processor 120 may allow call reception or transmission. Alternatively, when the counterpart's phone number does not match the set phone number, the processor 120 may block call reception or transmission. When the call is blocked, the processor 120 may transmit a call blocking notification message to the counterpart's electronic device and, the payment is completed, display the call reception message during payment.

When the processing result corresponds to the approval, the processor 120 may output, for example, payment information in operation 1339. The payment information may include seller payment information and/or consumer payment information. For example, the processor 120 may display the seller payment information and/or the consumer payment information on the display 160. Alternatively, the processor 120 may transmit the consumer payment information to the consumer through a message or email. For example, the processor 120 may transmit the consumer payment information to the electronic device of the consumer through short-range communication (for example, NFC or BT). The processor 120 may store the seller payment information in the secure area.

The operations (for example, operations 1001 to 1005, operations 1101 to 1107, operations 1201 to 1207, or operations 1301 to 1337) described in the processes and methods illustrated in FIGS. 10 to 13B may be performed in a sequential, parallel, repetitive, or heuristic type. For example, the operations may be performed in a different order, some of the operations may be omitted, or other operations may be added.

An operation method of an electronic device including a plurality of resources according to various embodiments may include an operation of executing an application for performing payment, an operation of selecting one or more resources to be used for the payment among the plurality of resources at least based on the execution, and an operation of performing the payment through the application by using the one or more resources.

The operation of selecting the one or more sources according to various embodiments may include an operation of selecting the one or more resources based on a capability of the electronic device, a role of the electronic device, an amount or a function related to the payment, or a combination thereof.

The operation of selecting the one or more sources according to various embodiments may include an operation of further selecting one or more resources other than the resources among the plurality of resources based on the role of the electronic device.

The electronic device according to various embodiments may include a portable terminal, and the operation of performing the payment may include an operation of transmitting or receiving payment information related to the payment to or from an external electronic device and performing the payment.

The electronic device according to various embodiments may further include a security module, and the operation of performing the payment may include an operation of performing the payment at least based on authentication information related to the payment acquired from the security module.

The resources according to various embodiments may include hardware functionally connected to the electronic device, software executed through the hardware, a command executed through a processor included in the electronic device, or a combination thereof.

The electronic device according to various embodiments may include a portable terminal, and the operation of executing the application may include an operation of identifying integrity information of the electronic device, and an operation of making a request for authentication information related to the payment based on the identification.

The operation method according to various embodiments may further include an operation of identifying the authentication information, and an operation of executing a payment processing mode based on the authentication information. The operation of performing the payment may include an operation of performing the payment through the application while the payment processing mode is executed.

The operation method according to various embodiments may further include an operation of determining effectiveness of the input information, and an operation of, when the information is not effective, limiting execution of a function corresponding to the information.

According to various embodiments, a storage medium having instructions stored therein may be provided. The instructions may be configured to allow one or more processors to perform one or more operations when being executed by the one or more processors. The one or more operations may include an operation of executing an application for performing payment in an electronic device including a plurality of resources, an operation of selecting one or more resources to be used for the payment among the plurality of resources at least based on the execution, and an operation of performing the payment through the application by using the one or more resources.

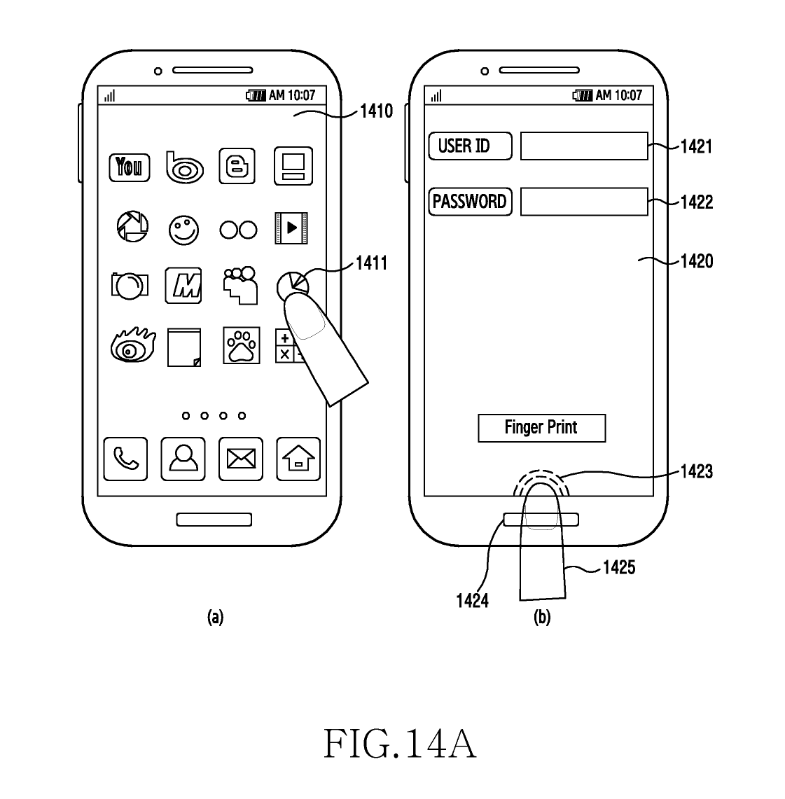

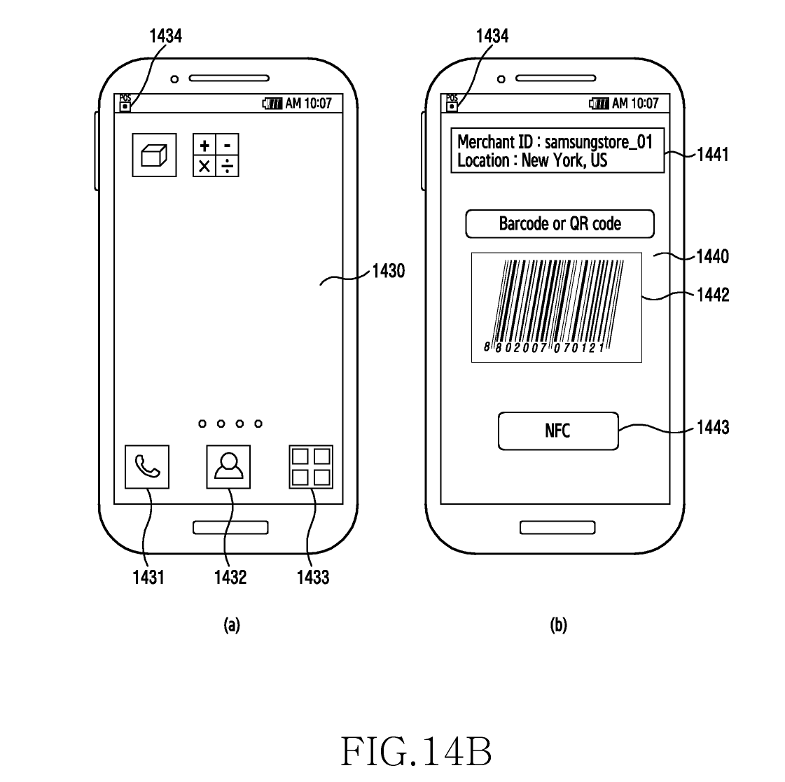

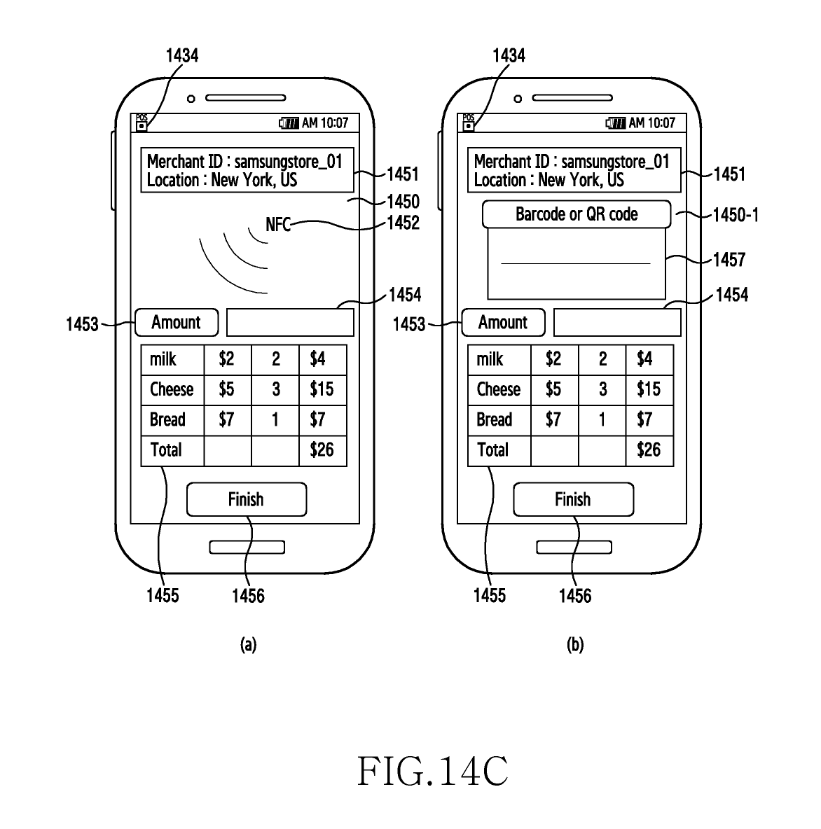

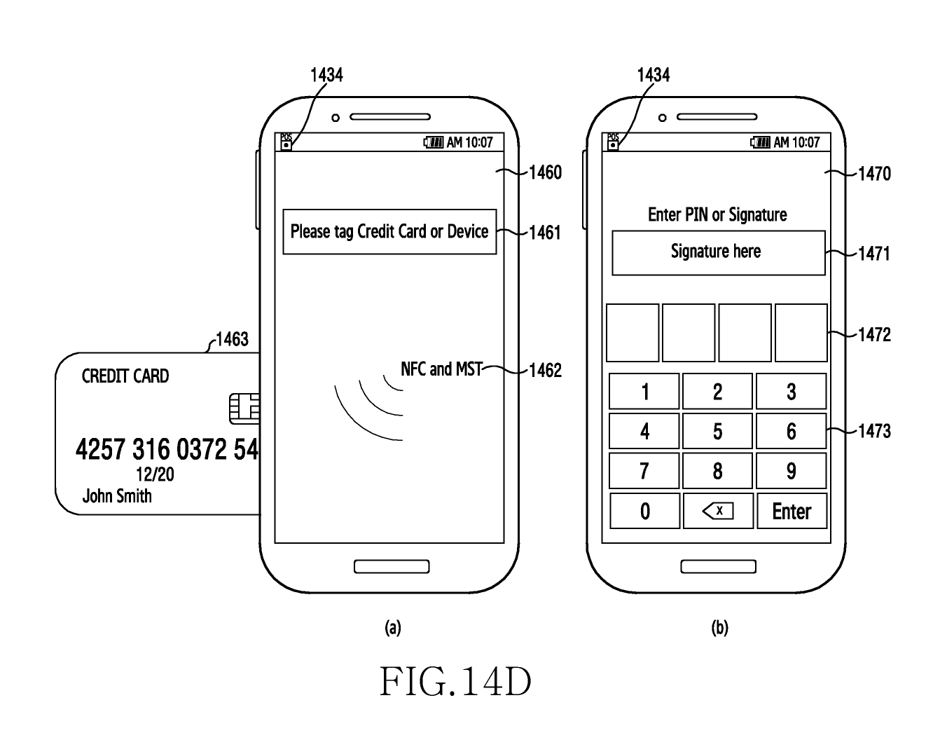

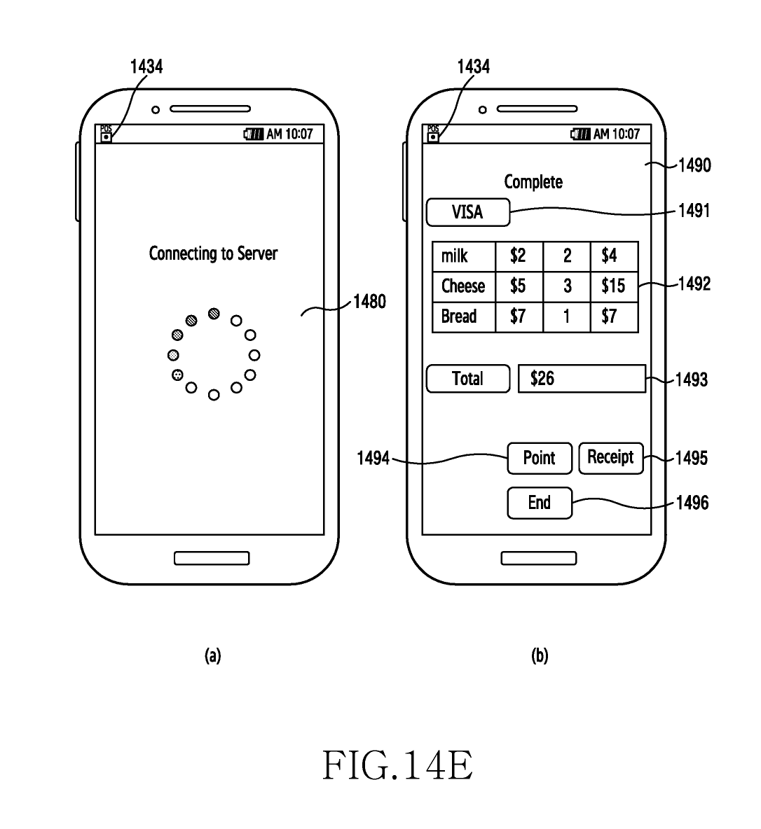

FIGS. 14A to 14E illustrate examples of a user interface screen of an electronic device according to various embodiments.

FIG. 14A(a) illustrates a user interface screen for executing a payment application.

Referring to FIG. 14A(a), the electronic device 101 (for example, the processor 120) may receive selection of an icon 1411 related to the payment application in a user interface 1410. The processor 120 may execute the payment application according to the selection of the icon 1411. The user interface 1410 may be a home screen in the normal mode of the electronic device 101.

FIG. 14A(b) illustrates a user interface screen for receiving a user authentication input.

Referring to FIG. 14A(b), the processor 120 may display a user interface 1420 for the user authentication after the payment application is executed. The user interface 1420 may include an ID input field 1421 for inputting a user ID, a P/W input field 1422 for inputting a password, and a finger print 1423 for inputting a fingerprint. Further, although not illustrated, when a cursor for the input is located at the ID input field 1421 or the P/W input field 1422, the processor 120 may display a keypad. The user may input his/her fingerprint by bringing a finger 1425 into contact with a home button 1424.

FIG. 14B(a) illustrates a user interface screen for executing a payment processing mode.

Referring to FIG. 14B(a), the processor 120 may display a user interface 1430 including an icon of an application allowed in the payment processing mode along with a notification 1434 informing of the payment processing mode. The payment processing mode notification 1434 may include an image, an icon, and text (for example, POS). The user interface 1430 may include a call application 1431 of which execution is allowed during execution of the payment processing mode, contacts 1432, and a payment processing mode end 1433. The payment processing mode is executed by the execution of the payment application, but the payment processing mode end icon 1433 may be displayed in the user interface 1430 so that, similar to another application, the payment processing mode is not easily terminated by a cancel button or a home button. When the payment processing mode end icon 1433 is selected, the processor 120 may end the payment processing mode and return to the normal mode. Alternatively, according to some embodiments, the payment processing mode end may be performed by the cancel button or the home button like another application end.

FIG. 14B(b) illustrates a user interface screen for a payment transaction.

Referring to FIG. 14B(b), when the payment processing mode notification 1434 is selected, the processor 120 may execute the payment transaction management module 931. According to an embodiment, after a user authentication, the processor 120 may immediately execute an application for the payment transaction. The user interface 1440 may be a screen on which a payment transaction application is executed. A user interface 1440 may include seller information 1441, a code scan area 1442, and an NFC execution button 1443. The seller information 1441 may include information on a seller using the electronic device 101 as the payment terminal. For example, the seller information 1441 may include a store ID (for example, samsungstore_01) and a store location (for example, Gangnam-gu, Seoul, Republic of Korea). The code scan area 1442 corresponds to an area for displaying a preview of a camera, and may be an area for scanning for a barcode or a QR code. The camera may be activated in the user interface 1440 and the preview of the camera may be displayed in the code scan area 1442. When the user controls the electronic device 101 such that the barcode or the QR code is placed in the code scan area 1442, the processor 120 may acquire information on the barcode or the QR code by recognizing the barcode or the QR code. When the NFC execution button 1443 is selected, the processor 120 may acquire information through NFC. The information may be card information.

FIG. 14C(a) illustrates a user interface screen for acquiring information through NFC.

Referring to FIG. 14C(a), when the NFC execution button 1443 is selected, the processor 120 may activate an NFC signal for acquiring information by using NFC through the communication service module 947. When the NFC execution button 1443 is selected, the processor 120 may display a user interface 1450. The user interface 1450 may include seller information 1451, an NFC execution notification 1452, an amount 1453, an amount input field 1454, a product list 1455, and a finish 1456. The seller information 1451 may include information on a seller using the electronic device 101 as the payment terminal. For example, the seller information 1451 may include a store ID (for example, samsungstore_01) and a store location (for example, Gangnam-gu, Seoul, Republic of Korea). The NFC execution notification 1452 may display text or an image informing that the electronic device 101 is communicating through NFC. The amount input field 1454 may show information on a number or an amount of products to be paid for. The product list 1455 may show a name, an amount, a number, and/or a total amount of each product to be paid for. When a product is selected in the product list 1455, the processor 120 may display a price of the selected product in the amount input field 1454.

FIG. 14C(b) illustrates a user interface screen for acquiring information through code scan.

Referring to FIG. 14C(b), when a code scan button 1442 is selected, the processor 120 may execute the camera module 291 to read the barcode or the QR code. When the code scan button 1442 is selected, the processor 120 may display a user interface 1450-1. The user interface 1450-1 may include the seller information 1451, a code scan area 1457, the amount 1453, the amount input field 1454, the product list 1455, and the finish 1456. The code scan area 1457 may be the same as the code scan area 1442 of FIG. 14B.

When the finish 1456 is selected, the processor 120 may proceed to a payment step.

FIG. 14D(a) illustrates a user interface screen for acquiring card information.

Referring to FIG. 14D(a), the processor 120 may read card-related information (for example, a token or PAN) from a card 1463 including a chip or the electronic device (for example, the consumer's electronic device) having an NFC function. The processor 120 may display a user interface 1460 for acquiring the card information. The user interface 1460 may include an NFC and MST execution notification 1462 along with a notification 1461 making a request for contacting or tagging the card or the device. The electronic device 101 may include a module for reading magnetic card information. The read card information may be processed through the payment transaction module 921. The payment transaction module 921 may temporarily store or encrypt the card information.

FIG. 14D(b) illustrates a user interface screen for authenticating the card.

Referring to FIG. 14D(b), the processor 120 may display a user interface 1470 for authenticating whether the acquired card information is effective. The user interface 1470 may include a signature area 1471, a password input area 1472, and a keypad 1473. The processor 120 may recognize a writing input made into the signature area 1471 as signature. The processor 120 may recognize and process the signature or the password as payment approval information.

FIG. 14E(a) illustrates a user interface screen for transmitting information.

Referring to FIG. 14E(a), the processor 120 may display a user interface 1480 for transmitting the card information and the payment approval information to the server 106. The server 106 may be at least one of the acquirer server 830, the token server 850, the issuer server 860, the payment server 870, and the online shopping server. Since a URL of the server 106 related to the payment is registered as an accessible URL, the processor 120 may access the URL of the server 106 even in the payment processing mode.

FIG. 14E(b) illustrates a user interface screen for outputting payment information.

Referring to FIG. 14E(b), when a payment processing result corresponds to approval, the processor 120 may display a user interface 1490 including payment information. The user interface 1490 may include a card type 1491, a transaction history 1492, a payment amount 1493, a point accumulation button 1494, a receipt issue 1495, and an end 1496. According to various embodiments, the payment information may include seller payment information and consumer payment information. For example, the processor 120 may display the seller payment information and/or the consumer payment information on the display 160. Alternatively, the processor 120 may transmit the consumer payment information to the consumer through a message or email. For example, the processor 120 may transmit the consumer payment information to the electronic device of the consumer through short-range communication (for example, NFC or BT). The processor 120 may store the seller payment information in the secure area.

According to various embodiments, the electronic device may display at least some of the user interfaces 1410, 1420, 1430, 1440, 1450, 1450-1, 1460, 1470, 1480, and 1490 through at least one of text, image, icon, floating icon, tile, and widget, or through a sound or vibration by means of the audio module or the motor (the motor 298 of FIG. 2) functionally connected to the electronic device. Further, the electronic device may change a scheme in which the electronic device outputs the user interface 1410, 1420, 1430, 1440, 1450, 1450-1, 1460, 1470, 1480, or 1490 to the outside, a color, luminosity, transparency, a display location, and a size, contents displayed in at least some of the interfaces, or a visual effect of the contents.

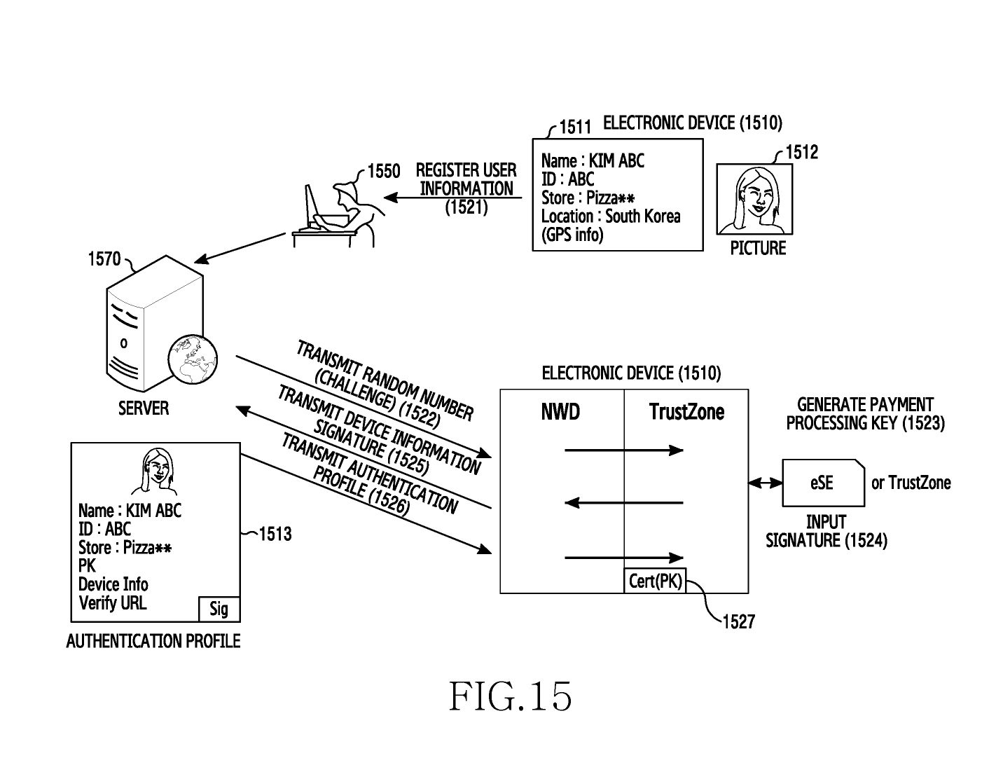

FIG. 15 illustrates a process for registering an electronic device as a POS terminal according to one embodiment of the present disclosure.

Referring to FIG. 15, in operation 1521, an electronic device 1510 (for example, the processor 120) may register, for example, user information 1511. The user information 1511 may include at least one of a photo 1512, a name (for example, Hong, Gil Dong), an ID (for example, DONG) (or a seller ID), store information (for example, Pizza Hut), and a location (for example, . . . , Seoul, Republic of Korea). The ID may include a password and biometric information. When the user desires to use the electronic device 1510 as a seller payment terminal, the user may submit the user information to a store manager 1550. The store manager 1550 may register the user information in a store management server 1570. Alternatively, the user may register the user information in the store management server 1570 by using the electronic device 1510.

In operation 1522, the store management server 1570 may receive, for example, registration of the user information and transmit a random number (challenge). The store management server 1570 may generate the random number based on the registered user information.

In operation 1523, the electronic device 1510 (for example, the processor 120) may generate a payment processing key (for example, mPOS Key) by using the random number. The mPOS Key may include a secret key and a public key for using the electronic device 1510 as the seller payment terminal. The electronic device 1510 may store the generated mPOS Key in an eSE or a trusted zone.

In operation 1524, the electronic device 1510 (for example, the processor 120) may receive, for example, signature from the user. The electronic device 1510 may identify device information. The device information may be an International Mobile Equipment Identity (IMEI) hash or a hardware serial number.

In operation 1525, the electronic device 1510 (for example, the processor 120) may transmit, for example, the device information and signature to the store management server 1570. The electronic device 1510 may transmit the random number (challenge), the store ID, and the signature to the store management server 1570 along with the device information.

In operation 1526, the store management server 1570 may transmit, for example, an authentication profile 1513 to the electronic device 1510. The store management server 1570 may generate the authentication profile 1513 by using at least one of the user information, the device information, and the signature. The authentication profile 1513 may be seller identification information for identifying the electronic device 1510 as the payment terminal when the electronic device 1510 is used as the payment terminal. The store management server 1570 may store the authentication profile 1513 including the signature in the user information and manage the user information.

In operation 1527, the electronic device 1510 (for example, the processor 120) may receive, for example, the authentication profile 1513 from the store management server 1570 and store the authentication profile 1513 in the secure area (for example, TrustZone). The electronic device 1510 may transmit the authentication profile 1513 to the server 106 in an operation of processing payment in the payment processing mode.

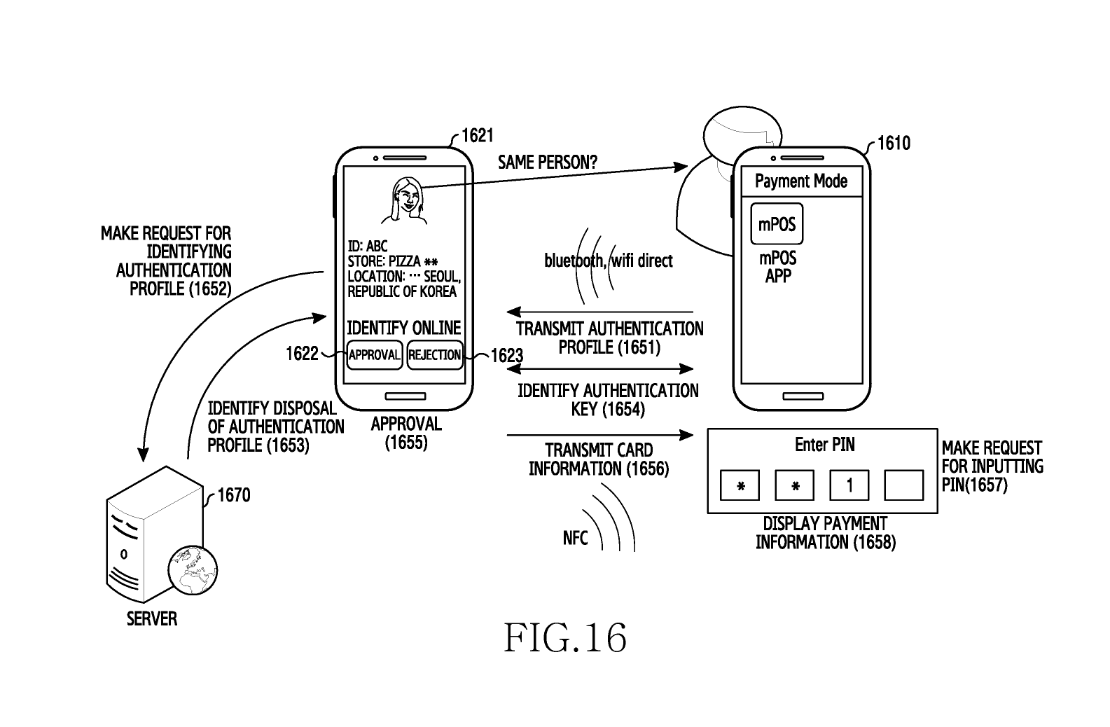

FIG. 16 illustrates a payment process using an electronic device according to various embodiments.

Referring to FIG. 16, in operation 1651, an electronic device 1621 (for example, the processor 120) may receive, for example, an authentication profile from a seller terminal 1610. The electronic device 1621 corresponds to the consumer's electronic device and may make a request for the authentication profile to identify whether the seller terminal 1610 is an authenticated payment terminal. The electronic device 1621 may receive the authentication profile from the seller terminal 1610 through Bluetooth or Wi-Fi.

In operation 1652, the electronic device 1621 (for example, the processor 120) may make a request for identifying the authentication profile to the store management server 1670.

In operation 1653, the store management server 1670 may identify, for example, revocation of the authentication profile. When the authentication profile is also stored in the store management server 1670, the authentication may be identified. When the authentication profile is not stored in the store management server 1670, the authentication may be rejected. When the authentication profile is not stored in the store management server 1670, the authentication profile may be an authentication profile which is expired or is not used. When the authentication profile is stored in the store management server 1670, the store management server 1670 may transmit a secret key or a public key corresponding to the authentication profile to the electronic device 1621.

In operation 1654, the electronic device 1621 (for example, the processor 120) may make a request for identifying an authentication key to the store management server 1670 together with the seller terminal 1610 after the identification of the store management server 1670.. The seller terminal 1610 may transmit a secret key or a public key corresponding to the authentication profile to the transmission device 1621.

In operation 1655, the electronic device 1621 (for example, the processor 120) may allow the seller terminal 1610 to be the payment terminal. The electronic device 1621 may select approval 1622 or rejection 1623 according to a result of the identification of the authentication key. When the public key of the store management server 1670 matches the public key of the seller terminal 1610, the electronic device 1621 may determine that the mutual authentication has been performed and select the approval 1622.

When allowed, in operation 1656, the electronic device 1621 (for example, the processor 120) may transmit, card information to the seller terminal 1610. The card information may be stored in the electronic device 1621, and the electronic device 1621 may read the card information from the card when the payment processing mode is executed. According to various embodiments, when the public key of the store management server 1670 does not match the public key of the seller terminal 1610, the electronic device 1621 may determine that the mutual authentication has not been performed and select the rejection 1623.

In operation 1657, the seller terminal 1610 may receive, for example, the card information from the electronic device 1621 and make a request for inputting a PIN for payment based on the card information. The seller terminal 1610 may display the user interface illustrated in FIG. 14D(b) to make the request for inputting the PIN. The seller terminal 1610 may transmit the card information and input PIN to the server 106 and receive a processing result from the server 106.

When the processing result corresponds to, for example, “approval”, the processor 1610 may output payment information in operation 1658. The payment information may include seller payment information and consumer payment information. For example, the seller terminal 1610 may display the seller payment information or the consumer payment information. Alternatively, the seller terminal 1610 may transmit the consumer payment information to the electronic device 1621 through a message or email. For example, the seller terminal 1610 may transmit the consumer payment information to the electronic device 1621 through short-range communication (for example, NFC or BT).

According to various embodiments, the electronic device may be controlled to be used as the POS terminal.

According to various embodiments, it is possible to improve security of the electronic device by controlling information related to payment in a secure area having a high security level.

According to various embodiment, when the electronic device operates in the payment processing mode, a payment policy of the POS terminal can be met by controlling a processor, which is not related to the payment, to be not executed.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for.”

What is claimed is:

1. A method comprising:
executing an application for performing payment in an electronic device including a plurality of resources;
selecting one or more resources of the electronic device to be used for performing the payment among the plurality of resources at least based on the execution; and
performing the payment through the application by using the one or more resources.

2. The method of claim 1, wherein the selecting of the one or more resources comprises selecting based on at least one of:
a capability of the electronic device;
a role of the electronic device;
an amount or a function related to the payment, or a combination thereof.

3. The method of claim 2, wherein the selecting of the one or more resources comprises further selecting one or more additional resources based on the role of the electronic device.

4. The method of claim 1, wherein the electronic device further comprises a portable terminal, and the performing of the payment further comprises:
transmitting or receiving payment information related to the payment to or from an external electronic device; and
performing the payment.

5. The method of claim 1, wherein the electronic device further comprises a security module, and the performing of the payment further comprises performing the payment at least based on authentication information related to the payment acquired from the security module.

6. The method of claim 1, wherein the resources include at least one of:
hardware connected to the electronic device;
software executed through the hardware;
a command executed through a processor included in the electronic device, or a combination thereof.

7. The method of claim 1, wherein the electronic device further comprises a portable terminal, and the executing of the application comprises:
performing an integrity check of the electronic device; and
making a request for authentication information related to the payment based on the integrity check.

8. The method of claim 7, further comprising:
identifying the authentication information; and
executing a payment processing mode based on the authentication information,
wherein the performing of the payment comprises performing the payment through the application while the payment processing mode is executing.

9. The method of claim 1, further comprising:
determining effectiveness of an input payment information for performing the payment; and
limiting execution of the payment when the input information is not effective.

10. An electronic device comprising:
a communication interface;
a display;
a memory; and
a processor functionally connected to the memory,
wherein the processor is configured to perform operations, the operations comprising:
executing an application for performing payment;
selecting one or more resources of the electronic device to be used for performing the payment among the plurality of resources at least based on the execution; and
performing the payment through the application by using the one or more resources.

11. The electronic device of claim 10, wherein the processor is configured to select based on at least one of:
a capability of the electronic device;
a role of the electronic device;
an amount or a function related to the payment, or a combination thereof.

12. The electronic device of claim 11, wherein the processor is configured to further select one or more additional resources based on the role of the electronic device.

13. The electronic device of claim 10, wherein the electronic device further comprises a portable terminal, and the processor is configured to transmit or receive payment information related to the payment to or from an external electronic device and to perform the payment.

14. The electronic device of claim 10, further comprising a security module and wherein the processor is configured to perform the payment at least based on authentication information related to the payment acquired from the security module.

15. The electronic device of claim 10, wherein the resources include at least one of:
hardware functionally connected to the electronic device;
software executed through the hardware;
a command executed through a processor included in the electronic device, or a combination thereof.

16. The electronic device of claim 10, wherein the electronic device further comprises a portable terminal, and the processor is further configured to perform operations comprising:
performing an integrity check of the electronic device; and
making a request for authentication information related to the payment based on the integrity check.

17. The electronic device of claim 16, wherein the processor is further configured to perform operations comprising:
identifying the authentication information;
executing a payment processing mode based on the authentication information; and
performing the payment through the application while the payment processing mode is executing.

18. The electronic device of claim 10, wherein the processor is further configured to perform operations comprising:
determining effectiveness of an input payment information for performing the payment; and
limiting execution of the payment when the input information is not effective.

19. The electronic device of claim 10, wherein the processor is configured to transmit payment information to a server, to receive a processing result from the server, and to output payment result information based on the processing result.

20. A computer-readable recording medium including a program to execute operations, the operations comprising:
executing an application for performing payment in an electronic device including a plurality of resources;
selecting one or more resources of the electronic device to be used for the performing payment among the plurality of resources at least based on the execution; and
performing the payment through the application by using the one or more resources.
